(19) United States
(12) Patent Application Publication
(10) Pub. No.: US 2024/0120531 A1
(43) Pub. Date: Apr. 11, 2024

(54) SOLID ELECTROLYTE MATERIAL AND BATTERY USING THE SAME

(71) Applicant: Panasonic Intellectual Property Management Co., Ltd., Osaka (JP)

(72) Inventors: TOMOYASU YOKOYAMA, Osaka (JP); KAZUHIDE ICHIKAWA, Kyoto (JP)

(21) Appl. No.: 18/528,710

(22) Filed: Dec. 4, 2023

Related U.S. Application Data
(63) Continuation of application No. PCT/JP2022/019580, filed on May 6, 2022.

(30) Foreign Application Priority Data
Jun. 17, 2021 (JP) 2021-101165

(51) Int. Cl. H01M 10/0562

(52) U.S. Cl. CPC H01M 10/0562; H01M 2300/0068

(57) ABSTRACT

A solid electrolyte material of the present disclosure includes an ion-conducting species and an anionic framework. The ion-conducting species is at least one element selected from the group consisting of alkali metal elements and alkaline earth metal elements. The anionic framework has a tetrahedral composite structure with no dihedral planes. A battery of the present disclosure includes a positive electrode, a negative electrode, and an electrolyte layer disposed between the positive electrode and the negative electrode. At least one selected from the group consisting of the positive electrode, the negative electrode, and the electrolyte layer includes the solid electrolyte material of the present disclosure.

### BACKGROUND

### 1. Technical Field

The present disclosure relates to a solid electrolyte material and a battery using the same.

### 2. Description of the Related Art

U.S. Patent Application Publication No. 2018/0366769 discloses solid electrolytes Li₈N₂Te, Li_{7.75}N_{1.75}Te_{1.25}, Li_{7.75}N_{1.75}Se_{1.25}, Li₈N₂S, and Li_{7.75}N_{1.75}S_{1.25} each having a MgCu₂-type anionic framework.

### SUMMARY

One non-limiting and exemplary embodiment provides a novel solid electrolyte material suited for ion conduction.

In one general aspect, the techniques disclosed here feature a solid electrolyte material including an ion-conducting species and an anionic framework, wherein the ion-conducting species is at least one element selected from the group consisting of alkali metal elements and alkaline earth metal elements, and the anionic framework has a tetrahedral composite structure with no dihedral planes.

The novel solid electrolyte material provided according to the present disclosure is suited for ion conduction.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a view illustrating a crystal structure of LiCl;

FIG. 1B is a view illustrating a tiling of anion polyhedra of LiCl;

FIG. 2A is a view illustrating a crystal structure of Li₆PS₅Cl;

FIG. 2B is a view illustrating a tiling of anion polyhedra of Li₆PS₅Cl;

FIGS. 3A to 3K are views illustrating exemplary polyhedra that form tetrahedral composite structures;

FIG. 4A is a view illustrating a MgCu₂-type crystal structure as a crystal structure of a metal material having a tetrahedral composite structure;

FIG. 4B is a view illustrating a Zr₄Al₃-type structure as a crystal structure of a metal material having a tetrahedral composite structure;

FIG. 4C is a view illustrating an Al₂Cu-type structure as a crystal structure of a metal material having a tetrahedral composite structure;

FIG. 4D is a view illustrating an AlB₂-type structure as a crystal structure of a metal material having a tetrahedral composite structure;

FIG. 4E is a view illustrating a ThSi₂-type structure as a crystal structure of a metal material having a tetrahedral composite structure;

FIG. 4F is a view illustrating a CrB-type structure as a crystal structure of a metal material having a tetrahedral composite structure;

FIG. 4G is a view illustrating an FeB-type structure as a crystal structure of a metal material having a tetrahedral composite structure;

FIG. 4H is a view illustrating a CaCu₅-type structure as a crystal structure of a metal material having a tetrahedral composite structure;

FIG. 4I is a view illustrating a NbBe₃-type structure as a crystal structure of a metal material having a tetrahedral composite structure;

FIG. 4J is a view illustrating a Ce₂Ni₇-type structure as a crystal structure of a metal material having a tetrahedral composite structure;

FIG. 4K is a view illustrating a Th₂Zn₇-type structure as a crystal structure of a metal material having a tetrahedral composite structure;

FIG. 5A is a view illustrating a tetrahedral tiling in the MgCu₂-type crystal structure as a crystal structure of a metal material having a tetrahedral composite structure;

FIG. 5B is a view illustrating a tetrahedral tiling in the Zr₄Al₃-type crystal structure as a crystal structure of a metal material having a tetrahedral composite structure;

FIG. 5C is a view illustrating a tetrahedral tiling in the Al₂Cu-type crystal structure as a crystal structure of a metal material having a tetrahedral composite structure;

FIG. 5D is a view illustrating a tetrahedral tiling in the AlB₂-type crystal structure as a crystal structure of a metal material having a tetrahedral composite structure;

FIG. 5E is a view illustrating a tetrahedral tiling in the ThSi₂-type crystal structure as a crystal structure of a metal material having a tetrahedral composite structure;

FIG. 5F is a view illustrating a tetrahedral tiling in the CrB-type crystal structure as a crystal structure of a metal material having a tetrahedral composite structure;

FIG. 5G is a view illustrating a tetrahedral tiling in the FeB-type crystal structure as a crystal structure of a metal material having a tetrahedral composite structure;

FIG. 5H is a view illustrating a tetrahedral tiling in the CaCu₅-type crystal structure as a crystal structure of a metal material having a tetrahedral composite structure;

FIG. 5I is a view illustrating a tetrahedral tiling in the NbBe₃-type crystal structure as a crystal structure of a metal material having a tetrahedral composite structure;

FIG. 5J is a view illustrating a tetrahedral tiling in the Ce₂Ni₇-type crystal structure as a crystal structure of a metal material having a tetrahedral composite structure;

FIG. 5K is a view illustrating a tetrahedral tiling in the Th₂Zn₇-type crystal structure as a crystal structure of a metal material having a tetrahedral composite structure;

FIG. 6 illustrates a sectional view of a battery 1000 according to the second embodiment;

FIG. 7 illustrates a schematic view of a pressure forming die 300 used to evaluate the ionic conductivity of a solid electrolyte material;

FIG. 8 is a graph illustrating Cole-Cole plots obtained by impedance measurement of solid electrolyte materials according to EXAMPLE 1 and COMPARATIVE EXAMPLE 1;

FIG. 9 is a graph illustrating initial discharge characteristics of a battery according to EXAMPLE 1;

FIG. 10 is a view illustrating a crystal structure of the solid electrolyte material according to EXAMPLE 1 optimized by ab initio calculation;

FIG. 11 is a view illustrating a crystal structure of a solid electrolyte material according to EXAMPLE 4 optimized by ab initio calculation;

FIG. 12 is a view illustrating a crystal structure of a solid electrolyte material according to EXAMPLE 5 optimized by ab initio calculation;

FIG. 13 is a view illustrating a crystal structure of a solid electrolyte material according to EXAMPLE 6 optimized by ab initio calculation;

FIG. 14 is a view illustrating a crystal structure of a solid electrolyte material according to EXAMPLE 7 optimized by ab initio calculation;

FIG. 15 is a view illustrating a crystal structure of a solid electrolyte material according to EXAMPLE 8 optimized by ab initio calculation;

FIG. 16 is a view illustrating a crystal structure of a solid electrolyte material according to EXAMPLE 9 optimized by ab initio calculation;

FIG. 17 is a view illustrating a crystal structure of a solid electrolyte material according to EXAMPLE 10 optimized by ab initio calculation;

FIG. 18 is a view illustrating a crystal structure of a solid electrolyte material according to EXAMPLE 11 optimized by ab initio calculation;

FIG. 19 is a view illustrating a crystal structure of a solid electrolyte material according to EXAMPLE 12 optimized by ab initio calculation;

FIG. 20 is a view illustrating a crystal structure of a solid electrolyte material according to EXAMPLE 13 optimized by ab initio calculation;

FIG. 21 is a view illustrating a crystal structure of a solid electrolyte material according to EXAMPLE 14 optimized by ab initio calculation;

FIG. 22 is a view illustrating a crystal structure of a solid electrolyte material according to EXAMPLE 15 optimized by ab initio calculation;

FIG. 23 is a view illustrating a crystal structure of a solid electrolyte material according to EXAMPLE 16 optimized by ab initio calculation;

FIG. 24 is a view illustrating a crystal structure of a solid electrolyte material according to EXAMPLE 17 optimized by ab initio calculation;

FIG. 25 is a view illustrating a crystal structure of a solid electrolyte material according to EXAMPLE 18 optimized by ab initio calculation;

FIG. 26 is a view illustrating a crystal structure of a solid electrolyte material according to EXAMPLE 19 optimized by ab initio calculation;

FIG. 27 is a view illustrating a crystal structure of a solid electrolyte material according to EXAMPLE 20 optimized by ab initio calculation;

FIG. 28 is a view illustrating a crystal structure of a solid electrolyte material according to EXAMPLE 21 optimized by ab initio calculation;

FIG. 29 is a view illustrating a crystal structure of a solid electrolyte material according to EXAMPLE 22 optimized by ab initio calculation;

FIG. 30 is a view illustrating a crystal structure of a solid electrolyte material according to EXAMPLE 23 optimized by ab initio calculation;

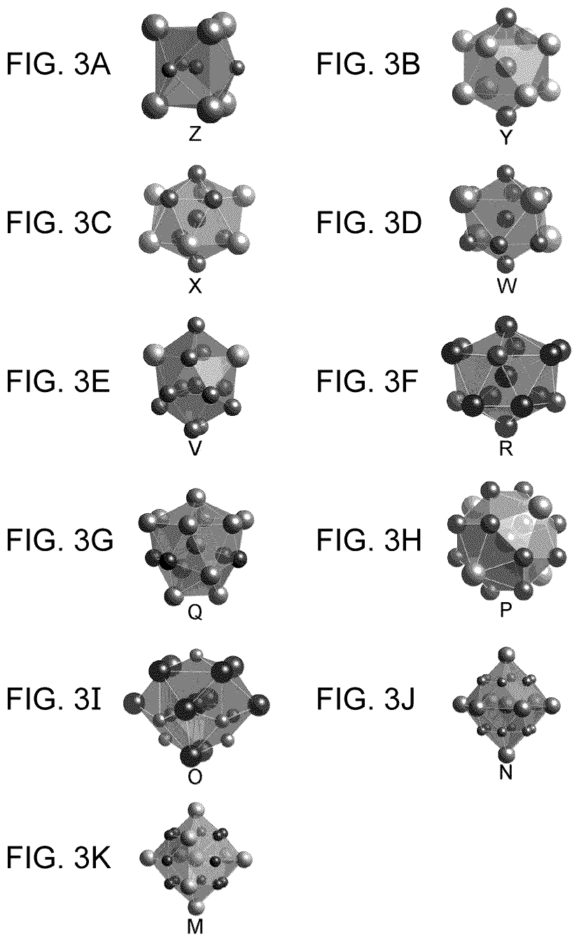

FIG. 3I is a view illustrating a crystal structure of a solid electrolyte material according to EXAMPLE 24 optimized by ab initio calculation;

FIG. 32 is a view illustrating a crystal structure of a solid electrolyte material according to EXAMPLE 25 optimized by ab initio calculation;

FIG. 33 is a view illustrating a crystal structure of a solid electrolyte material according to EXAMPLE 26 optimized by ab initio calculation;

FIG. 34 is a view illustrating a crystal structure of a solid electrolyte material according to EXAMPLE 27 optimized by ab initio calculation;

FIG. 35 is a view illustrating a crystal structure of a solid electrolyte material according to EXAMPLE 28 optimized by ab initio calculation;

FIG. 36 is a view illustrating a crystal structure of a solid electrolyte material according to EXAMPLE 29 optimized by ab initio calculation;

FIG. 37 is a view illustrating a crystal structure of a solid electrolyte material according to EXAMPLE 30 optimized by ab initio calculation;

FIG. 38 is a view illustrating a crystal structure of a solid electrolyte material according to EXAMPLE 31 optimized by ab initio calculation;

FIG. 39 is a view illustrating a crystal structure of a solid electrolyte material according to EXAMPLE 32 optimized by ab initio calculation;

FIG. 40 is a view illustrating a crystal structure of the solid electrolyte material according to COMPARATIVE EXAMPLE 1 optimized by ab initio calculation;

FIG. 41 is a view illustrating a crystal structure of a solid electrolyte material according to COMPARATIVE EXAMPLE 4 optimized by ab initio calculation;

FIG. 42 is a graph illustrating the temperature dependence of the Li ion diffusion coefficient of the solid electrolyte material according to EXAMPLE 1 calculated by ab initio molecular dynamics calculation;

FIG. 43 is a graph illustrating the temperature dependence of the Li ion diffusion coefficient of the solid electrolyte material according to EXAMPLE 4 calculated by ab initio molecular dynamics calculation;

FIG. 44 is a graph illustrating the temperature dependence of the Li ion diffusion coefficient of the solid electrolyte material according to EXAMPLE 5 calculated by ab initio molecular dynamics calculation;

FIG. 45 is a graph illustrating the temperature dependence of the Li ion diffusion coefficient of the solid electrolyte material according to EXAMPLE 6 calculated by ab initio molecular dynamics calculation;

FIG. 46 is a graph illustrating the temperature dependence of the Li ion diffusion coefficient of the solid electrolyte material according to EXAMPLE 7 calculated by ab initio molecular dynamics calculation;

FIG. 47 is a graph illustrating the temperature dependence of the Li ion diffusion coefficient of the solid electrolyte material according to EXAMPLE 8 calculated by ab initio molecular dynamics calculation;

FIG. 48 is a graph illustrating the temperature dependence of the Li ion diffusion coefficient of the solid electrolyte material according to EXAMPLE 9 calculated by ab initio molecular dynamics calculation;

FIG. 49 is a graph illustrating the temperature dependence of the Li ion diffusion coefficient of the solid electrolyte material according to EXAMPLE 10 calculated by ab initio molecular dynamics calculation;

FIG. 50 is a graph illustrating the temperature dependence of the Li ion diffusion coefficient of the solid electrolyte material according to EXAMPLE 11 calculated by ab initio molecular dynamics calculation;

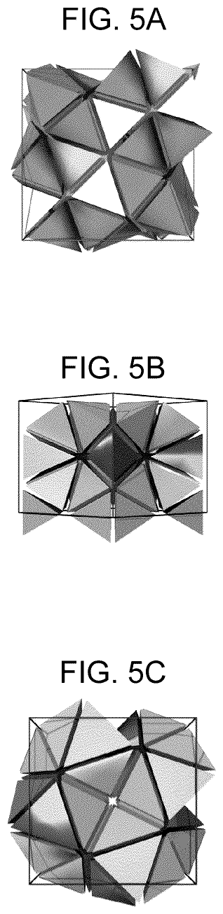

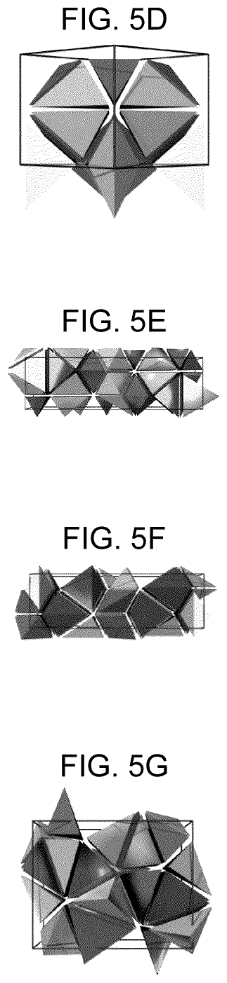

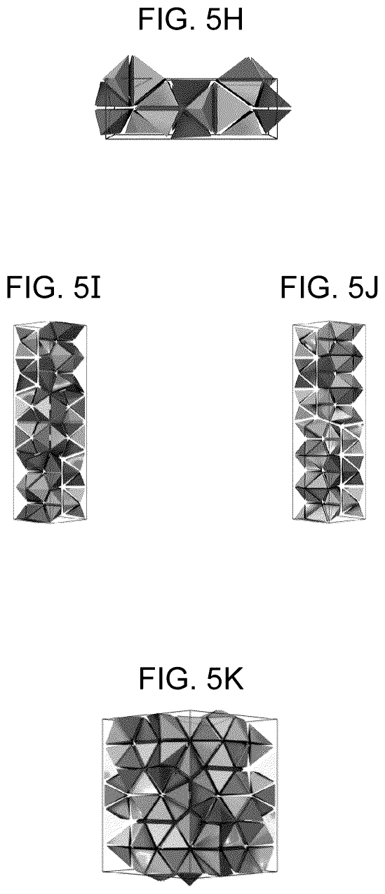

FIG. 5I is a graph illustrating the temperature dependence of the Li ion diffusion coefficient of the solid electrolyte material according to EXAMPLE 12 calculated by ab initio molecular dynamics calculation;

FIG. 52 is a graph illustrating the temperature dependence of the Li ion diffusion coefficient of the solid electrolyte material according to EXAMPLE 13 calculated by ab initio molecular dynamics calculation;

FIG. 53 is a graph illustrating the temperature dependence of the Li ion diffusion coefficient of the solid electrolyte material according to EXAMPLE 14 calculated by ab initio molecular dynamics calculation;

FIG. 54 is a graph illustrating the temperature dependence of the Li ion diffusion coefficient of the solid electrolyte material according to EXAMPLE 15 calculated by ab initio molecular dynamics calculation;

FIG. 55 is a graph illustrating the temperature dependence of the Li ion diffusion coefficient of the solid electrolyte material according to EXAMPLE 16 calculated by ab initio molecular dynamics calculation;

FIG. 56 is a graph illustrating the temperature dependence of the Li ion diffusion coefficient of the solid electrolyte material according to EXAMPLE 17 calculated by ab initio molecular dynamics calculation;

FIG. 57 is a graph illustrating the temperature dependence of the Li ion diffusion coefficient of the solid electrolyte material according to EXAMPLE 18 calculated by ab initio molecular dynamics calculation;

FIG. 58 is a graph illustrating the temperature dependence of the Li ion diffusion coefficient of the solid electrolyte material according to EXAMPLE 19 calculated by ab initio molecular dynamics calculation;

FIG. 59 is a graph illustrating the temperature dependence of the Li ion diffusion coefficient of the solid electrolyte material according to EXAMPLE 20 calculated by ab initio molecular dynamics calculation;

FIG. 60 is a graph illustrating the temperature dependence of the Li ion diffusion coefficient of the solid electrolyte material according to EXAMPLE 21 calculated by ab initio molecular dynamics calculation;

FIG. 61 is a graph illustrating the temperature dependence of the Li ion diffusion coefficient of the solid electrolyte material according to EXAMPLE 22 calculated by ab initio molecular dynamics calculation;

FIG. 62 is a graph illustrating the temperature dependence of the Li ion diffusion coefficient of the solid electrolyte material according to EXAMPLE 23 calculated by ab initio molecular dynamics calculation;

FIG. 63 is a graph illustrating the temperature dependence of the Li ion diffusion coefficient of the solid electrolyte material according to EXAMPLE 24 calculated by ab initio molecular dynamics calculation;

FIG. 64 is a graph illustrating the temperature dependence of the Li ion diffusion coefficient of the solid electrolyte material according to EXAMPLE 25 calculated by ab initio molecular dynamics calculation;

FIG. 65 is a graph illustrating the temperature dependence of the Li ion diffusion coefficient of the solid electrolyte material according to EXAMPLE 26 calculated by ab initio molecular dynamics calculation;

FIG. 66 is a graph illustrating the temperature dependence of the Li ion diffusion coefficient of the solid electrolyte material according to EXAMPLE 27 calculated by ab initio molecular dynamics calculation;

FIG. 67 is a graph illustrating the temperature dependence of the Li ion diffusion coefficient of the solid electrolyte material according to EXAMPLE 28 calculated by ab initio molecular dynamics calculation;

FIG. 68 is a graph illustrating the temperature dependence of the Li ion diffusion coefficient of the solid electrolyte material according to EXAMPLE 29 calculated by ab initio molecular dynamics calculation;

FIG. 69 is a graph illustrating the temperature dependence of the Li ion diffusion coefficient of the solid electrolyte material according to EXAMPLE 30 calculated by ab initio molecular dynamics calculation;

FIG. 70 is a graph illustrating the temperature dependence of the Li ion diffusion coefficient of the solid electrolyte material according to EXAMPLE 31 calculated by ab initio molecular dynamics calculation;

FIG. 71 is a graph illustrating the temperature dependence of the Li ion diffusion coefficient of the solid electrolyte material according to EXAMPLE 32 calculated by ab initio molecular dynamics calculation;

FIG. 72 is a graph illustrating the temperature dependence of the Li ion diffusion coefficient of the solid electrolyte material according to COMPARATIVE EXAMPLE 1 calculated by ab initio molecular dynamics calculation;

FIG. 73 is a graph illustrating the temperature dependence of the Li ion diffusion coefficient of the solid electrolyte material according to COMPARATIVE EXAMPLE 3 calculated by ab initio molecular dynamics calculation; and

FIG. 74 is a graph illustrating an X-ray diffraction pattern of the solid electrolyte material according to EXAMPLE 1.

### DETAILED DESCRIPTIONS

Hereinafter, embodiments of the present disclosure will be described with reference to the drawings. The present disclosure is not limited to the following embodiments.

### First Embodiment

A solid electrolyte material according to the first embodiment includes an ion-conducting species and an anionic framework. The ion-conducting species is at least one element selected from the group consisting of alkali metal elements and alkaline earth metal elements. The anionic framework has a tetrahedral composite structure with no dihedral planes.

The solid electrolyte material according to the first embodiment is a solid electrolyte material suited for achieving enhanced ionic conductivity. For example, the solid electrolyte material according to the first embodiment has high lithium ionic conductivity. Thus, the solid electrolyte material according to the first embodiment may be used to obtain a battery having excellent charge-discharge characteristics. An example of the batteries is an all-solid-state secondary battery.

Here, the high lithium ionic conductivity is, for example, greater than or equal to 7×10⁻⁵ S/cm at around room temperature (for example, 25° C.). For example, the solid electrolyte material according to the first embodiment can have an ionic conductivity of greater than or equal to 7×10⁻⁵ S/cm.

The solid electrolyte material according to the first embodiment may be used to obtain a battery having excellent charge-discharge characteristics. An example of the batteries is an all-solid-state battery. The all-solid-state battery may be a primary battery or a secondary battery.

The anionic framework is a crystal structure composed of anions, and, for example, consists of anions. Specifically, for example, the anionic framework is a crystal structure consisting of negatively charged ions (namely, anions) that remain after removal of positively charged ions (namely, cations) from the ionic crystal. For example, the anionic framework of Li₆PS₅Cl is a crystal structure composed of the anions S²⁻ and Cl⁻ after removal of the cations Li⁺ and P⁵⁺.

XPS measurement may be used to determine whether an element constituting the solid electrolyte material is an anion or a cation. When the bond energy obtained by XPS measurement is lower than that of the elemental metal, the element is negatively charged and can be judged to be an anion. When, in contrast, the bond energy is higher than that of the elemental metal, the element is positively charged and can be regarded as a cation. For example, P is an anion in InP. The bond energy of the 2p orbital of P in InP is 128.9 eV and is lower than the bond energy of the 2p orbital of elemental P, 130.1 eV. On the other hand, P is a cation in P₄O₁₀. The bond energy of the 2p orbital of P in P₄O₁₀ is 135.5 eV and is higher than the bond energy of elemental P.

In the solid electrolyte material, the ion-conducting species diffuses while interacting with the anionic framework. Thus, the geometry of the anionic framework significantly affects the ion conduction.

The tetrahedral composite structure is a structure that is filled (tiled) with almost regular tetrahedra in which atoms are located at the vertex positions of the tetrahedra. A crystal structure can be judged as being a tetrahedral composite structure when the interstitial sites obtained by centroidal Voronoi tessellation of atoms in the crystal structure are tetrahedral sites, that is, four-coordinated sites, and the tetrahedral sites represent greater than or equal to 85% of all the interstitial sites. For example, the centroidal Voronoi tessellation can be evaluated using Topography Analyzer class of Pymatgen, a library of the programming language python.

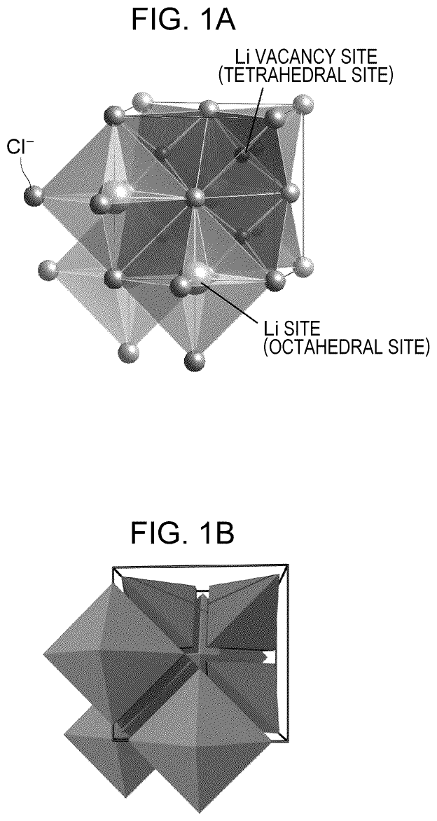

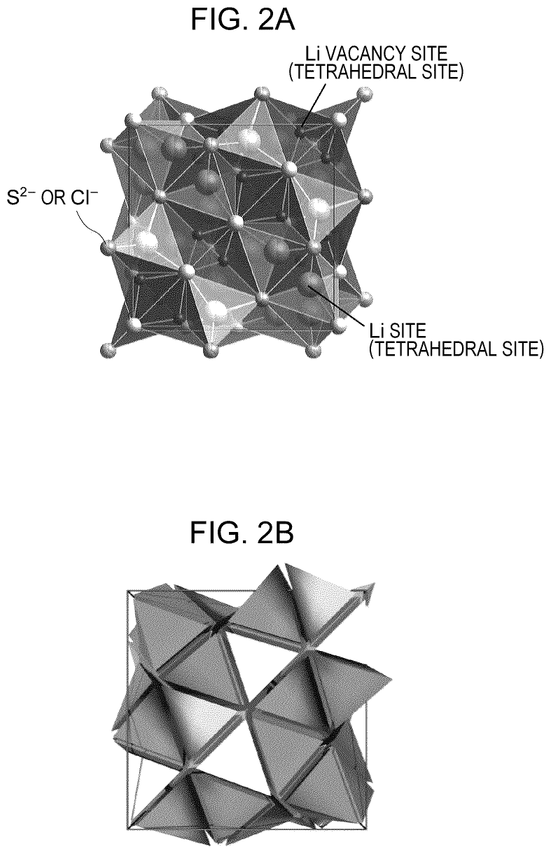

By virtue of the anionic framework having a tetrahedral composite structure, the activation energy for the diffusion of ions in the solid electrolyte material can be lowered and the solid electrolyte material exhibits high ion conductivity. If the potentials (the site energies) experienced by an ion differ, the ion cannot diffuse continuously from one site to an adjacent site. For example, this will be discussed with respect to LiCl and Li₆PS₅Cl as examples. Here, FIG. 1A is a view illustrating a crystal structure of LiCl, and FIG. 1B is a view illustrating a tiling of anion polyhedra of LiCl. FIG. 2A is a view illustrating a crystal structure of Li₆PS₅Cl, and FIG. 2B is a view illustrating a tiling of anion polyhedra of Li₆PS₅Cl. For example, the anionic framework of LiCl has a face-centered cubic lattice structure (that is, a fcc structure) in which a Cl⁻ tetrahedron and a Cl⁻ octahedron share a plane (see FIG. 1A and FIG. 1B). In this case, a Li ion at the tetrahedral site and a Li ion at the octahedral site have different coordination environments and therefore the Li ions experience different potentials. In LiCl, the tetrahedral site has a higher potential than the octahedral site and the Li ion in the octahedral site cannot diffuse to the tetrahedral site. Thus, the ion conductivity is low. On the other hand, the anionic framework of Li₆PS₅Cl has a MgCu₂-type structure in which a S²⁻ tetrahedron and a Cl⁻ tetrahedron share a plane (see FIG. 2A and FIG. 2B). In this case, all the sites adjacent to one another are tetrahedral sites and therefore Li ions experience the same potentials in all the sites and can diffuse easily to adjacent sites. Thus, high ion conductivity is exhibited. Incidentally, the MgCu₂-type structure belongs to the tetrahedral composite structures.

Some tetrahedral composite structures have been discovered so far.

FIGS. 3A to 3K are views illustrating exemplary polyhedra that form tetrahedral composite structures. The polyhedron Z in FIG. 3A has 14 faces and belongs to the point group D₃ₕ. The polyhedron Y in FIG. 3B has 16 faces and belongs to the point group D₄. The polyhedron X in FIG. 3C has 20 faces and belongs to the point group Dad. The polyhedron W in FIG. 3D has 20 faces and belongs to the point group D₂ₕ. The polyhedron V in FIG. 3E has 22 faces and belongs to the point group C₂ᵥ. The polyhedron R in FIG. 3F has 24 faces and belongs to the point group D_{2d}. The polyhedron Q in FIG. 3G has 26 faces and belongs to the point group C₂ᵥ. The polyhedron P in FIG. 3H has 28 faces and belongs to the point group Td. The polyhedron I in FIG. 3I has 30 faces and belongs to the point group C₂ᵥ. The polyhedron N in FIG. 3J has 36 faces and belongs to the point group Tn. The polyhedron M in FIG. 3K has 36 faces and belongs to the point group D_{2d}.

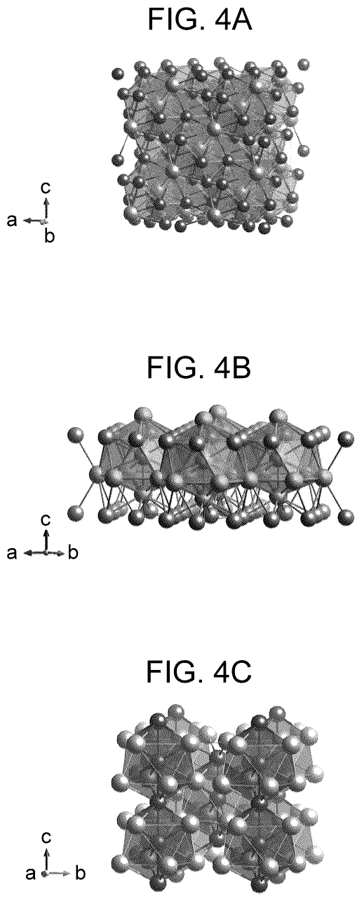

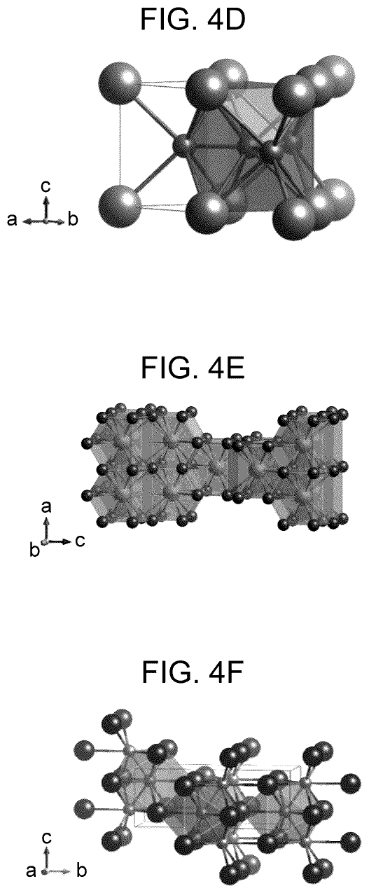

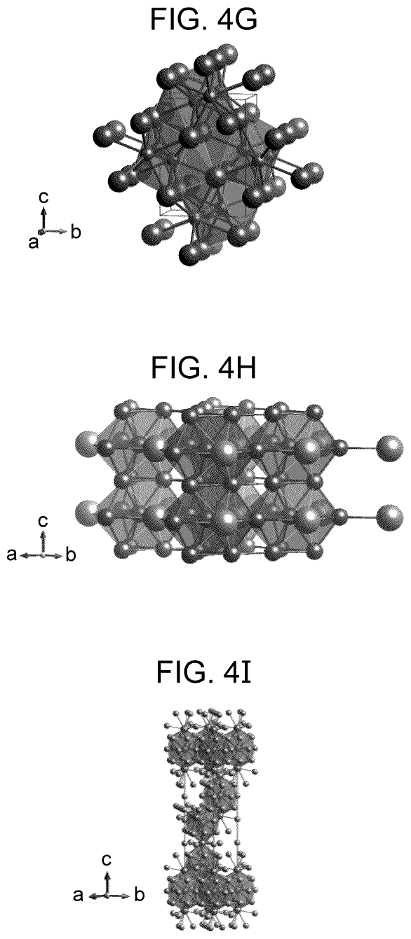

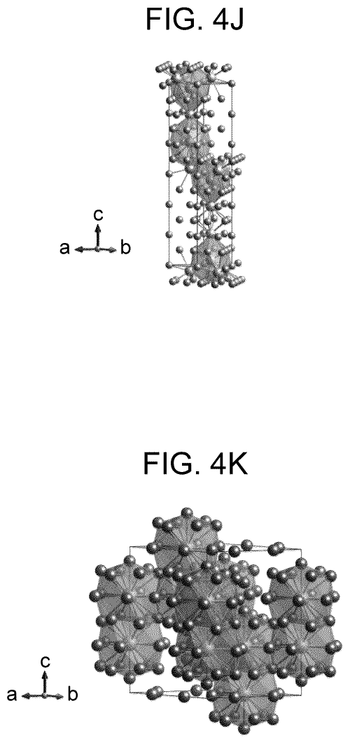

FIG. 4A is a view illustrating a MgCu₂-type crystal structure as a crystal structure of a metal material having a tetrahedral composite structure. FIG. 4B is a view illustrating a Zr₄Al₃-type structure as a crystal structure of a metal material having a tetrahedral composite structure. FIG. 4C is a view illustrating an Al₂Cu-type structure as a crystal structure of a metal material having a tetrahedral composite structure. FIG. 4D is a view illustrating an AlB₂-type structure as a crystal structure of a metal material having a tetrahedral composite structure. FIG. 4E is a view illustrating a ThSi₂-type structure as a crystal structure of a metal material having a tetrahedral composite structure. FIG. 4F is a view illustrating a CrB-type structure as a crystal structure of a metal material having a tetrahedral composite structure. FIG. 4G is a view illustrating an FeB-type structure as a crystal structure of a metal material having a tetrahedral composite structure. FIG. 4H is a view illustrating a CaCu₅-type structure as a crystal structure of a metal material having a tetrahedral composite structure. FIG. 4I is a view illustrating a NbBe₃-type structure as a crystal structure of a metal material having a tetrahedral composite structure. FIG. 4J is a view illustrating a Ce₂Ni₇-type structure as a crystal structure of a metal material having a tetrahedral composite structure. FIG. 4K is a view illustrating a Th₂Zn₇-type structure as a crystal structure of a metal material having a tetrahedral composite structure.

FIG. 5A is a view illustrating a tetrahedral tiling in the MgCu₂-type crystal structure as a crystal structure of a metal material having a tetrahedral composite structure. FIG. 5B is a view illustrating a tetrahedral tiling in the Zr₄Al₃-type crystal structure as a crystal structure of a metal material having a tetrahedral composite structure. FIG. 5C is a view illustrating a tetrahedral tiling in the Al₂Cu-type crystal structure as a crystal structure of a metal material having a tetrahedral composite structure. FIG. 5D is a view illustrating a tetrahedral tiling in the AlB₂-type crystal structure as a crystal structure of a metal material having a tetrahedral composite structure. FIG. 5E is a view illustrating a tetrahedral tiling in the ThSi₂-type crystal structure as a crystal structure of a metal material having a tetrahedral composite structure. FIG. 5F is a view illustrating a tetrahedral tiling in the CrB-type crystal structure as a crystal structure of a metal material having a tetrahedral composite structure. FIG. 5G is a view illustrating a tetrahedral tiling in the FeB-type crystal structure as a crystal structure of a metal material having a tetrahedral composite structure. FIG. 5H is a view illustrating a tetrahedral tiling in the CaCu₅-type crystal structure as a crystal structure of a metal material having a tetrahedral composite structure. FIG. 5I is a view illustrating a tetrahedral tiling in the NbBe₃-type crystal structure as a crystal structure of a metal material having a tetrahedral composite structure. FIG. 5J is a view illustrating a tetrahedral tiling in the Ce₂Ni₇-type crystal structure as a crystal structure of a metal material having a tetrahedral composite structure. FIG. 5K is a view illustrating a tetrahedral tiling in the Th₂Zn₇-type crystal structure as a crystal structure of a metal material having a tetrahedral composite structure.

Table 1 lists the tetrahedral composite structures and the polyhedra forming the tetrahedral composite structures.

In some cases, the composition of the anions does not agree with the composition of MgCu₂ that is the parent structure for the anionic framework. For example, this is the case in Li₆PS₅Cl. Specifically, the Mg:Cu ratio in MgCu₂ is 1:2, whereas the S:Cl ratio in Li₆PS₅Cl is 5:1. MgCu₂ is composed of an icosaoctahedron in which 4 Mg atoms and 12 Cu atoms are coordinated around a Mg atom, similarly to the polyhedron P with 28 faces illustrated in FIG. 3H. On the other hand, Li₆PS₅Cl is composed of an icosaoctahedron in which 0 Cl atoms and 16 S atoms are coordinated around a Cl atom. Incidentally, these icosaoctahedra have the same symmetry. As described above, the compositional ratio of the anions does not necessarily agree with the compositional ratio of the metal material that is the parent structure for the anionic framework.

For example, Li₆PS₅Cl having a MgCu₂-type structure is known as a compound with high ionic conductivity exceeding 1 mS/cm. The MgCu₂-type structure is composed of two tetrahedral composites, specifically, an icosaoctahedron centered on a Mg atom and having point group Td symmetry (that is, the polyhedron P illustrated in FIG. 3H) and an icosahedron centered on a Cu atom and having point group Dad symmetry (that is, the polyhedron X illustrated in FIG. 3C). As indicated by the symbol d in the point groups, the tetrahedral composites of these polyhedra P and X have a symmetry plane that is a dihedral plane.

A dihedral plane is a symmetry plane that includes the principal axis of rotation and bisects the angle formed between axes perpendicular to the principal axis of rotation. The presence of a dihedral plane means that the structure has three-dimensional isotropic symmetry. Incidentally, for example, a crystal structure having a dihedral plane is sometimes called an inversion symmetric crystal structure. When the anionic framework is composed solely of a tetrahedral composite having a dihedral plane, as is the case in a MgCu₂-type structure, an ion-conducting species diffuses isotropically in three dimensions. However, an ion-conducting species diffuses more easily in two-dimensional or one-dimensional conduction pathways and higher ion conductivity will be obtained than in three-dimensional conduction pathways. Thus, a structure having a tetrahedral composite with no dihedral planes exhibits higher ion conductivity than a structure composed of a tetrahedral composite having a dihedral plane, such as a MgCu₂-type structure. In fact, Li₇NTe₂ composed of a MgCu₂-type anionic framework consisting of a polyhedron with a dihedral plane was measured to have an ionic conductivity of 1.87 mS/cm by ab initio calculation. On the other hand, Li₇NTe₂ composed of an Al₂Cu-type anionic framework consisting of a tetrahedral composite with no dihedral planes had an ionic conductivity of 53.4 mS/cm according to ab initio calculation. As described above, the anionic framework having a tetrahedral composite structure with no dihedral planes is suited for enhancing the ion conductivity of a solid electrolyte material. In the solid electrolyte material according to the first embodiment, the anionic framework has at least one tetrahedral composite structure with no dihedral planes.

Examples of the crystal structures that include a tetrahedral composite structure with no dihedral planes include Zr₄Al₃-type structures, Al₂Cu-type structures, AlB₂-type structures, ThSi₂-type structures, CrB-type structures, FeB-type structures, CaCu₅-type structures, NbBe₃-type structures, Ce₂Ni₇-type structures, and Th₂Zn₇-type structures. That is, the solid electrolyte material can exhibit high ion conductivity when the anionic framework has any of these crystal structures. To attain an increased ionic conductivity, the anionic framework in the solid electrolyte material according to the first embodiment has, for example, a Zr₄Al₃-type structure, an Al₂Cu-type structure, an AlB₂-type structure, a ThSi₂-type structure, a CrB-type structure, an FeB-type structure, a CaCu₅-type structure, a NbBe₃-type structure, a Ce₂Ni₇-type structure, or a Th₂Zn₇-type structure.

In order to increase the ionic conductivity of the solid electrolyte material, the tetrahedral composite structure in the anionic framework of the solid electrolyte material according to the first embodiment may have a structure belonging to at least one point group selected from the group consisting of Iₕ, Oₕ, Tₕ, Cₛ, Cᵢ, C₁, S₂ₙ, Dₙₕ, Dₙ, Cₙₕ, Cₙᵥ, and Cₙ. In order to further increase the ionic conductivity of the solid electrolyte material, the tetrahedral composite structure in the anionic framework of the solid electrolyte material according to the first embodiment may have a structure belonging to at least one point group selected from the group consisting of Tₕ, C₂ᵥ, D₂ₕ, D₃ₕ, and D₄. The letter n in the above point groups is an integer.

TABLE 1

| | | Type of tetrahedral composite | | | | | | | | | | |
|---|---|---|---|---|---|---|---|---|---|---|---|---|
| | | Number of faces | | | | | | | | | | |
| | | 14 | 16 | 20 | 20 | 22 | 24 | 26 | 28 | 30 | 36 | 36 |
| | | Number of vertices | | | | | | | | | | |
| | | 9 | 10 | 12 | 12 | 13 | 14 | 15 | 16 | 17 | 20 | 20 |
| | | Symbol | | | | | | | | | | |
| | | Z | Y | W | X | V | R | Q | P | 0 | N | M |
| | | Point group | | | | | | | | | | |
| | | D₃ₕ | D₄ | D₂ₕ | D_{3d} | C₂ᵥ | D_{2d} | C₂ᵥ | T_{d} | C₂ᵥ | Tₕ | D_{2d} |
| Crystal | Space | Dihedral plane | | | | | | | | | | |
| structure | group | Absent | Absent | Absent | Present | Absent | Present | Absent | Present | Absent | Absent | Present |
| MgCu₂-type | Fd3-m | 0 | 0 | 0 | 2 | 0 | 0 | 0 | 1 | 0 | 0 | 0 |
| Zr₄Al₃-type | P6/mmm | 0 | 0 | 0 | 3 | 0 | 2 | 2 | 0 | 0 | 0 | 0 |
| Al₂Cu-type | I4/mcm | 0 | 1 | 0 | 0 | 0 | 0 | 2 | 0 | 0 | 0 | 0 |
| AlB₂-type | P6/mmm | 2 | 0 | 0 | 0 | 0 | 0 | 0 | 0 | 0 | 1 | 0 |
| ThSi₂-type | I4₁/amd | 2 | 0 | 0 | 0 | 0 | 0 | 0 | 0 | 0 | 0 | 1 |
| CrB-type | Cmcm | 1 | 0 | 0 | 0 | 0 | 0 | 0 | 0 | 1 | 0 | 0 |
| FeB-type | Pnma | 1 | 0 | 0 | 0 | 0 | 0 | 0 | 0 | 1 | 0 | 0 |
| CaCu₅-type | P6/mmm | 0 | 0 | 2 | 3 | 0 | 0 | 0 | 0 | 0 | 1 | 0 |
| NbBe₃-type | R3-m | 0 | 0 | 2 | 7 | 0 | 0 | 0 | 2 | 0 | 1 | 0 |
| Ce₂Ni₇-type | P6₃/mmc | 0 | 0 | 2 | 5 | 0 | 0 | 0 | 1 | 0 | 1 | 0 |
| Th₂Zn₇-type | R3-m | 0 | 0 | 0 | 9 | 6 | 2 | 0 | 0 | 0 | 2 | 0 |

The solid electrolyte material according to the first embodiment may contain elements that are incidentally mixed. Examples of such elements include hydrogen, nitrogen, and oxygen. Such elements may be present in ingredient powders for the solid electrolyte material or in the atmosphere in which the solid electrolyte material is produced or stored. For example, the amount of such elements incidentally mixed in the solid electrolyte material according to the first embodiment is less than or equal to 1 mol %.

In order to increase the ion conductivity, the ion-conducting species in the solid electrolyte material according to the first embodiment may include lithium. The ion-conducting species may be lithium.

Hereinafter, the solid electrolyte materials according to the first embodiment will be described with respect to each of the crystal structures of the anionic frameworks, taking as an example the case where the ion-conducting species includes lithium.

Zr₄Al₃-Type Structures

In the solid electrolyte material according to the first embodiment, the anionic framework may have a Zr₄Al₃-type structure.

The solid electrolyte material according to the first embodiment may be a material that includes an anionic framework having a Zr₄Al₃-type structure and is represented by compositional formula (1) below:

Li_{3x+4z}X₃Z₄ (1)

In compositional formula (1), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z. When X includes a plurality of elements, the elements have the same valence as one another. When Z includes a plurality of elements, the elements have the same valence as one another. The same applies also to compositional formulas (2) to (38) below.

The solid electrolyte material according to the first embodiment may be a material that includes an anionic framework having a Zr₄Al₃-type structure and is represented by compositional formula (2) below:

Li_{6x+z}X₆Z (2)

In compositional formula (2), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (2), for example, X may be Te and Z may be N. In this case, formula (2) is represented by the compositional formula: Li₁₅Te₆N.

The solid electrolyte material according to the first embodiment may be a material that includes an anionic framework having a Zr₄Al₃-type structure and is represented by compositional formula (3) below:

Li_{3x+4z-a}AX₃Z₄ (3)

In compositional formula (3), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a Zr₄Al₃-type structure and is represented by compositional formula (4) below:

Li_{3x+4z-2a}A₂X₃Z₄ (4)

In compositional formula (4), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

In compositional formula (4), for example, X may be at least one selected from the group consisting of O, Se, and S; Z may be at least one selected from the group consisting of Cl and I; and A may be at least one selected from the group consisting of Pb, Al, and In. In this case, formula (4) is represented by the compositional formula: Li₆Pb₂X₃Z₄, Li₄Al₂X₃Z₄, or Li₄In₂X₃Z₄.

The solid electrolyte material according to the first embodiment may be a material that includes an anionic framework having a Zr₄Al₃-type structure and is represented by compositional formula (5) below:

Li_{6x+z-a}AX₆Z (5)

In compositional formula (5), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a Zr₄Al₃-type structure and is represented by compositional formula (6) below:

Li_{6x+z-2a}A₂X₆Z (6)

In compositional formula (6), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (1) to (6) represent compositions in which the ion-conducting species is lithium, the ion-conducting species for the anionic frameworks having a Zr₄Al₃-type structure is not limited to lithium. For example, the solid electrolyte material according to the first embodiment may be represented by any of compositional formulas (1a) to (6a) below in which “MA” denotes an alkali metal element contained as the ion-conducting species. When the ion-conducting species in compositional formulas (1a) to (6a) includes a plurality of alkali metal elements, the compositional ratio of MA is determined from the total of the amounts of substance of all the alkali metal elements. In compositional formulas (1a) to (6a), X, Z, A, x, z, and a are the same as in compositional formulas (1) to (6).

MA_{3x+4z}X₃Z₄ (1a)

MA_{6x+z}X₆Z (2a)

MA_{3x+4z-a}AX₃Z₄ (3a)

MA_{3x+4z-2a}A₂X₃Z₄ (4a)

MA_{6x+z-a}AX₆Z (5a)

MA_{6x+z-2a}A₂X₆Z (6a)

When the anionic framework has a Zr₄Al₃-type structure, the ion-conducting species may be an alkaline earth metal element. For example, the solid electrolyte material according to the first embodiment may be represented by any of compositional formulas (1b) to (6b) below in which “MB” denotes an alkaline earth metal element contained as the ion-conducting species. When the ion-conducting species in compositional formulas (1b) to (6b) includes a plurality of alkaline earth metal elements, the compositional ratio of MB is determined from the total of the amounts of substance of all the alkaline earth metal elements. In compositional formulas (1b) to (6b), X, Z, A, x, z, and a are the same as in compositional formulas (1) to (6).

MB_{(3x+4z)/2}X₃Z₄ (1b)

MB_{(6x+z)/2}X₆Z (2b)

MB_{(3x+4z-a)/2}AX₃Z₄ (3b)

MB_{(3x+4z-2a)/2}A₂X₃Z₄ (4b)

MB_{(6x+z-a)/2}AX₆Z (5b)

MB_{(6x+z-2a)/2}A₂X₆Z (6b)

### Al₂Cu-Type Structures

In the solid electrolyte material according to the first embodiment, the anionic framework may have an Al₂Cu-type structure.

The solid electrolyte material according to the first embodiment may be a material that includes an anionic framework having an Al₂Cu-type structure and is represented by compositional formula (7) below:

Li_{2x+z}X₂Z (7)

In compositional formula (7), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (7), X may be at least one selected from the group consisting of Se and Te; and Z may be N. In this case, formula (7) is represented by the compositional formula: Li₇X₂N.

The solid electrolyte material according to the first embodiment may be a material that includes an anionic framework having an Al₂Cu-type structure and is represented by compositional formula (8) below:

Li_{3x+z}X₃Z (8)

In compositional formula (8), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (8), X may be Te, and Z may be N. In this case, formula (8) is represented by the compositional formula: Li₉Te₃N.

The solid electrolyte material according to the first embodiment may be a material that includes an anionic framework having an Al₂Cu-type structure and is represented by compositional formula (9) below:

Li_{7x+3z}X₇Z₃ (9)

In compositional formula (9), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (9), X may be Te, and Z may be N. In this case, formula (9) is represented by the compositional formula: Li₂₃Te₇N₃.

The solid electrolyte material according to the first embodiment may be a material that includes an anionic framework having an Al₂Cu-type structure and is represented by compositional formula (10) below:

Li_{5x+z}X₅Z (10)

In compositional formula (10), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (10), X may be at least one selected from the group consisting of Br and I; and Z may be N. In this case, formula (10) is represented by the compositional formula: Li₈X₅N.

The solid electrolyte material according to the first embodiment may be a material that includes an anionic framework having an Al₂Cu-type structure and is represented by compositional formula (11) below:

Li_{2x+z-a}AX₂Z (11)

In compositional formula (11), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

In compositional formula (11), for example, X may be at least one selected from the group consisting of S and Se; Z may be F; and A may be at least one selected from the group consisting of Zn and Mg. In this case, formula (11) is represented by the compositional formula: Li₃A₂X₂F.

The solid electrolyte material according to the first embodiment may be a material that includes an anionic framework having an Al₂Cu-type structure and is represented by compositional formula (12) below:

Li_{5x+z-a}AX₅Z (12)

In compositional formula (12), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having an Al₂Cu-type structure and is represented by compositional formula (13) below:

Li_{4x+2z-a}AX₄Z₂ (13)

In compositional formula (13), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having an Al₂Cu-type structure and is represented by compositional formula (14) below:

Li_{10x+2z-a}AX₁₀Z₂ (14)

In compositional formula (14), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (7) to (14) represent compositions in which the ion-conducting species is lithium, the ion-conducting species for the anionic frameworks having an Al₂Cu-type structure is not limited to lithium. For example, the solid electrolyte material according to the first embodiment may be represented by any of compositional formulas (7a) to (14a) below in which “MA” denotes an alkali metal element contained as the ion-conducting species. When the ion-conducting species in compositional formulas (7a) to (14a) includes a plurality of alkali metal elements, the compositional ratio of MA is determined from the total of the amounts of substance of all the alkali metal elements. In compositional formulas (7a) to (14a), X, Z, A, x, z, and a are the same as in compositional formulas (7) to (14).

MA_{2x+z}X₂Z (7a)

MA_{3x+z}X₃Z (8a)

MA_{7x+3z}X₇Z₃ (9a)

MA_{5x+z}X₅Z (10a)

MA_{2x+z-a}AX₂Z (11a)

MA_{5x+z-a}AX₅Z (12a)

MA_{4x+2z-a}AX₄Z₂ (13a)

MA_{10x+2z-a}AX₁₀Z₂ (14a)

When the anionic framework has an Al₂Cu-type structure, the ion-conducting species may be an alkaline earth metal element. For example, the solid electrolyte material according to the first embodiment may be represented by any of compositional formulas (7b) to (14b) below in which “MB” denotes an alkaline earth metal element contained as the ion-conducting species. When the ion-conducting species in compositional formulas (7b) to (14b) includes a plurality of alkaline earth metal elements, the compositional ratio of MB is determined from the total of the amounts of substance of all the alkaline earth metal elements. In compositional formulas (7b) to (14b), X, Z, A, x, z, and a are the same as in compositional formulas (7) to (14).

MB_{(2x+z)/2}X₂Z (7b)

MB_{(3x+z)/2}X₃Z (8b)

MB_{(7x+3z)/2}X₇Z₃ (9b)

MB_{(5x+z)/2}X₅Z (10b)

MB_{(2x+z-a)/2}AX₂Z (11b)

MB_{(5x+z-a)/2}AX₅Z (12b)

MB_{(4x+2z-a)/2}AX₄Z₂ (13b)

MB_{(10x+2z-a)/2}AX₁₀Z₂ (14b)

### AlB₂-Type Structures

In the solid electrolyte material according to the first embodiment, the anionic framework may have an AlB₂-type structure.

The solid electrolyte material according to the first embodiment may be a material that includes an anionic framework having an AlB₂-type structure and is represented by compositional formula (15) below:

Li_{x+2z}XZ₂ (15)

In compositional formula (15), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having an AlB₂-type structure and is represented by compositional formula (16) below:

Li_{x+2z-a}AXZ₂ (16)

In compositional formula (16), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having an AlB₂-type structure and is represented by compositional formula (17) below:

Li_{2x+4z-a}AX₂Z₄ (17)

In compositional formula (17), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (15) to (17) represent compositions in which the ion-conducting species is lithium, the ion-conducting species for the anionic frameworks having an AlB₂-type structure is not limited to lithium. For example, the solid electrolyte material according to the first embodiment may be represented by any of compositional formulas (15a) to (17a) below in which “MA” denotes an alkali metal element contained as the ion-conducting species. When the ion-conducting species in compositional formulas (15a) to (17a) includes a plurality of alkali metal elements, the compositional ratio of MA is determined from the total of the amounts of substance of all the alkali metal elements. In compositional formulas (15a) to (17a), X, Z, A, x, z, and a are the same as in compositional formulas (15) to (17).

MA_{x+2z}XZ₂ (15a)

MA_{x+2z-a}AXZ₂ (16a)

MA_{2x+4z-a}AX₂Z₄ (17a)

When the anionic framework has an AlB₂-type structure, the ion-conducting species may be an alkaline earth metal element. For example, the solid electrolyte material according to the first embodiment may be represented by any of compositional formulas (15b) to (17b) below in which “MB” denotes an alkaline earth metal element contained as the ion-conducting species. When the ion-conducting species in compositional formulas (15b) to (17b) includes a plurality of alkaline earth metal elements, the compositional ratio of MB is determined from the total of the amounts of substance of all the alkaline earth metal elements. In compositional formulas (15b) to (17b), X, Z, A, x, z, and a are the same as in compositional formulas (15) to (17).

MB_{(x+2z)/2}XZ₂ (15b)

MB_{(x+2z-a)/2}AXZ₂ (16b)

MB_{(2x+4z-a)/2}AX₂Z₄ (17b)

### ThSi₂-Type Structures

In the solid electrolyte material according to the first embodiment, the anionic framework may have a ThSi₂-type structure.

The solid electrolyte material according to the first embodiment may be a material that includes an anionic framework having a ThSi₂-type structure and is represented by compositional formula (18) below:

Li_{x+2z}XZ₂ (18)

In compositional formula (18), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having a ThSi₂-type structure and is represented by compositional formula (19) below:

Li_{x+2z-a}AXZ₂ (19)

In compositional formula (19), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a ThSi₂-type structure and is represented by compositional formula (20) below:

Li_{2x+4z-a}AX₂Z₄ (20)

In compositional formula (20), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (18) to (20) represent compositions in which the ion-conducting species is lithium, the ion-conducting species for the anionic frameworks having a ThSi₂-type structure is not limited to lithium. For example, the solid electrolyte material according to the first embodiment may be represented by any of compositional formulas (18a) to (20a) below in which “MA” denotes an alkali metal element contained as the ion-conducting species. When the ion-conducting species in compositional formulas (18a) to (20a) includes a plurality of alkali metal elements, the compositional ratio of MA is determined from the total of the amounts of substance of all the alkali metal elements. In compositional formulas (18a) to (20a), X, Z, A, x, z, and a are the same as in compositional formulas (18) to (20).

MA_{x+2z}XZ₂ (18a)

MA_{x+2z-a}AXZ₂ (19a)

MA_{2x+4z-a}AX₂Z₄ (20a)

When the anionic framework has a ThSi₂-type structure, the ion-conducting species may be an alkaline earth metal element. For example, the solid electrolyte material according to the first embodiment may be represented by any of compositional formulas (18b) to (20b) below in which “MB” denotes an alkaline earth metal element contained as the ion-conducting species. When the ion-conducting species in compositional formulas (18b) to (20b) includes a plurality of alkaline earth metal elements, the compositional ratio of MB is determined from the total of the amounts of substance of all the alkaline earth metal elements. In compositional formulas (18b) to (20b), X, Z, A, x, z, and a are the same as in compositional formulas (18) to (20).

MB_{(x+2z)/2}XZ₂ (18b)

MB_{(x+2z-a)/2}AXZ₂ (19b)

MB_{(2x+4z-a)/2}AX₂Z₄ (20b)

### CrB-Type Structures

In the solid electrolyte material according to the first embodiment, the anionic framework may have a CrB-type structure.

The solid electrolyte material according to the first embodiment may be a material that includes an anionic framework having a CrB-type structure and is represented by compositional formula (21) below:

Li_{x+z}XZ (21)

In compositional formula (21), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having a CrB-type structure and is represented by compositional formula (22) below:

Li_{x+z-a}AXZ (22)

In compositional formula (22), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a CrB-type structure and is represented by compositional formula (23) below:

Li_{2x+2z-a}AX₂Z₂ (23)

In compositional formula (23), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (21) to (23) represent compositions in which the ion-conducting species is lithium, the ion-conducting species for the anionic frameworks having a CrB-type structure is not limited to lithium. For example, the solid electrolyte material according to the first embodiment may be represented by any of compositional formulas (21a) to (23a) below in which “MA” denotes an alkali metal element contained as the ion-conducting species. When the ion-conducting species in compositional formulas (21a) to (23a) includes a plurality of alkali metal elements, the compositional ratio of MA is determined from the total of the amounts of substance of all the alkali metal elements. In compositional formulas (21a) to (23a), X, Z, A, x, z, and a are the same as in compositional formulas (21) to (23).

MA_{x+z}XZ (21a)

MA_{x+z-a}AXZ (22a)

MA_{2x+2z-a}AX₂Z₂ (23a)

When the anionic framework has a CrB-type structure, the ion-conducting species may be an alkaline earth metal element. For example, the solid electrolyte material according to the first embodiment may be represented by any of compositional formulas (21b) to (23b) below in which “MB” denotes an alkaline earth metal element contained as the ion-conducting species. When the ion-conducting species in compositional formulas (21b) to (23b) includes a plurality of alkaline earth metal elements, the compositional ratio of MB is determined from the total of the amounts of substance of all the alkaline earth metal elements. In compositional formulas (21b) to (23b), X, Z, A, x, z, and a are the same as in compositional formulas (21) to (23).

MA_{(x+z)/2}XZ (21b)

MA_{(x+z-a)/2}AXZ (22b)

MB_{(2x+2z-a)/2}AX₂Z₂ (23b)

### FeB-Type Structures

In the solid electrolyte material according to the first embodiment, the anionic framework may have an FeB-type structure.

The solid electrolyte material according to the first embodiment may be a material that includes an anionic framework having an FeB-type structure and is represented by compositional formula (24) below:

Li_{x+z}XZ (24)

In compositional formula (24), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having an FeB-type structure and is represented by compositional formula (25) below:

Li_{x+z-a}AXZ (25)

In compositional formula (25), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

In compositional formula (25), for example, X may be at least one selected from the group consisting of S and Se; Z may be at least one selected from the group consisting of N and Te; and A may be Ca. In this case, formula (25) is represented by the compositional formula: Li₃CaXZ.

The solid electrolyte material according to the first embodiment may be a material that includes an anionic framework having an FeB-type structure and is represented by compositional formula (26) below:

Li_{2x+2z-a}AX₂Z₂ (26)

In compositional formula (26), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (24) to (26) represent compositions in which the ion-conducting species is lithium, the ion-conducting species for the anionic frameworks having an FeB-type structure is not limited to lithium. For example, the solid electrolyte material according to the first embodiment may be represented by any of compositional formulas (24a) to (26a) below in which “MA” denotes an alkali metal element contained as the ion-conducting species. When the ion-conducting species in compositional formulas (24a) to (26a) includes a plurality of alkali metal elements, the compositional ratio of MA is determined from the total of the amounts of substance of all the alkali metal elements. In compositional formulas (24a) to (26a), X, Z, A, x, z, and a are the same as in compositional formulas (24) to (26).

MA_{x+z}XZ (24a)

MA_{x+z-a}AXZ (25a)

MA_{2x+2z-a}AX₂Z₂ (26a)

When the anionic framework has an FeB-type structure, the ion-conducting species may be an alkaline earth metal element. For example, the solid electrolyte material according to the first embodiment may be represented by any of compositional formulas (24b) to (26b) below in which “MB” denotes an alkaline earth metal element contained as the ion-conducting species. When the ion-conducting species in compositional formulas (24b) to (26b) includes a plurality of alkaline earth metal elements, the compositional ratio of MB is determined from the total of the amounts of substance of all the alkaline earth metal elements. In compositional formulas (24b) to (26b), X, Z, A, x, z, and a are the same as in compositional formulas (24) to (26).

MB_{(x+z)/2}XZ (24b)

MB_{(x+z-a)/2}AXZ (25b)

MB_{(2x+2z-a)/2}AX₂Z₂ (26b)

### CaCu₅-Type Structures

In the solid electrolyte material according to the first embodiment, the anionic framework may have a CaCu₅-type structure.

The solid electrolyte material according to the first embodiment may be a material that includes an anionic framework having a CaCu₅-type structure and is represented by compositional formula (27) below:

Li_{x+5z}XZ₅ (27)

In compositional formula (27), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (27), X may be at least one selected from the group consisting of Te and I; and Z may be at least one selected from the group consisting of Br, N, P, and As. In this case, formula (27) is represented by the compositional formula: Li₇XZ₅ or Li₁₆XZ₅.

The solid electrolyte material according to the first embodiment may be a material that includes an anionic framework having a CaCu₅-type structure and is represented by compositional formula (28) below:

Li_{x+5z-a}AXZ₅ (28)

In compositional formula (28), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a CaCu₅-type structure and is represented by compositional formula (29) below:

Li_{2x+10z-a}AX₂Z₁₀ (29)

In compositional formula (29), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (27) to (29) represent compositions in which the ion-conducting species is lithium, the ion-conducting species for the anionic frameworks having a CaCu₅-type structure is not limited to lithium. For example, the solid electrolyte material according to the first embodiment may be represented by any of compositional formulas (27a) to (29a) below in which “MA” denotes an alkali metal element contained as the ion-conducting species. When the ion-conducting species in compositional formulas (27a) to (29a) includes a plurality of alkali metal elements, the compositional ratio of MA is determined from the total of the amounts of substance of all the alkali metal elements. In compositional formulas (27a) to (29a), X, Z, A, x, z, and a are the same as in compositional formulas (27) to (29).

MA_{x+5z}XZ₅ (27a)

MA_{x+5z-a}AXZ₅ (28a)

MA_{2x+10z-a}AX₂Z₁₀ (29a)

When the anionic framework has a CaCu₅-type structure, the ion-conducting species may be an alkaline earth metal element. For example, the solid electrolyte material according to the first embodiment may be represented by any of compositional formulas (27b) to (29b) below in which “MB” denotes an alkaline earth metal element contained as the ion-conducting species. When the ion-conducting species in compositional formulas (27b) to (29b) includes a plurality of alkaline earth metal elements, the compositional ratio of MB is determined from the total of the amounts of substance of all the alkaline earth metal elements. In compositional formulas (27b) to (29b), X, Z, A, x, z, and a are the same as in compositional formulas (27) to (29).

MB_{(x+5z)/2}XZ₅ (27b)

MB_{(x+5z-a)/2}AXZ₅ (28b)

MB_{(2x+10z-a)/2}AX₂Z₁₀ (29b)

### NbBe₃-Type Structures

In the solid electrolyte material according to the first embodiment, the anionic framework may have a NbBe₃-type structure.

The solid electrolyte material according to the first embodiment may be a material that includes an anionic framework having a NbBe₃-type structure and is represented by compositional formula (30) below:

Li_{x+3z}XZ₃ (30)

In compositional formula (30), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

In compositional formula (30), X may be at least one selected from the group consisting of Br, I, Se, and Te; and Z may be N. In this case, formula (30) is represented by the compositional formula: Li₁₀XZ₃ or Li₁₁XZ₃.

The solid electrolyte material according to the first embodiment may be a material that includes an anionic framework having a NbBe₃-type structure and is represented by compositional formula (31) below:

Li_{x+3z-a}AXZ₃ (31)

In compositional formula (31), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a NbBe₃-type structure and is represented by compositional formula (32) below:

Li_{3x+9z-2a}A₂X₃Z₉ (32)

In compositional formula (32), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

In compositional formula (32), X may be at least one selected from the group consisting of Se, Te, S, and I; Z may be at least one selected from the group consisting of N and P; and A may be at least one selected from the group consisting of Zn, Mg, Si, Ge, Sn, Ga, In, and Al. In this case, formula (32) is represented by the compositional formula Li₂₉A₂X₃Z₉, Li₂₇A₂X₃Z₉, Li₂₅A₂X₃Z₉, or Li₂₄A₂X₃Z₉.

While compositional formulas (30) to (32) represent compositions in which the ion-conducting species is lithium, the ion-conducting species for the anionic frameworks having a NbBe₃-type structure is not limited to lithium. For example, the solid electrolyte material according to the first embodiment may be represented by any of compositional formulas (30a) to (32a) below in which “MA” denotes an alkali metal element contained as the ion-conducting species. When the ion-conducting species in compositional formulas (30a) to (32a) includes a plurality of alkali metal elements, the compositional ratio of MA is determined from the total of the amounts of substance of all the alkali metal elements. In compositional formulas (30a) to (32a), X, Z, A, x, z, and a are the same as in compositional formulas (30) to (32).

MA_{x+3z}XZ₃ (30a)

MA_{x+3z-a}AXZ₃ (31a)

MA_{3x+9z-2a}A₂X₃Z₉ (32a)

When the anionic framework has a NbBe₃-type structure, the ion-conducting species may be an alkaline earth metal element. For example, the solid electrolyte material according to the first embodiment may be represented by any of compositional formulas (30b) to (32b) below in which “MB” denotes an alkaline earth metal element contained as the ion-conducting species. When the ion-conducting species in compositional formulas (30b) to (32b) includes a plurality of alkaline earth metal elements, the compositional ratio of MB is determined from the total of the amounts of substance of all the alkaline earth metal elements. In compositional formulas (30b) to (32b), X, Z, A, x, z, and a are the same as in compositional formulas (30) to (32).

MB_{(x+3z)/2}XZ₃ (30b)

MB_{(x+3z-a)/2}AXZ₃ (31b)

MB_{(3x+9z-2a)/2}A₂X₃Z₉ (32b)

Ce₂Ni₇-Type Structures

In the solid electrolyte material according to the first embodiment, the anionic framework may have a Ce₂Ni₇-type structure.

The solid electrolyte material according to the first embodiment may be a material that includes an anionic framework having a Ce₂Ni₇-type structure and is represented by compositional formula (33) below:

Li_{2x+7z}X₂Z₇ (33)

In compositional formula (33), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having a Ce₂Ni₇-type structure and is represented by compositional formula (34) below:

Li_{2x+7z-a}AX₂Z₇ (34)

In compositional formula (34), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a Ce₂Ni₇-type structure and is represented by compositional formula (35) below:

Li_{4x+14z-a}AX₄Z₁₄ (35)

In compositional formula (35), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (33) to (35) represent compositions in which the ion-conducting species is lithium, the ion-conducting species for the anionic frameworks having a Ce₂Ni₇-type structure is not limited to lithium. For example, the solid electrolyte material according to the first embodiment may be represented by any of compositional formulas (33a) to (35a) below in which “MA” denotes an alkali metal element contained as the ion-conducting species. When the ion-conducting species in compositional formulas (33a) to (35a) includes a plurality of alkali metal elements, the compositional ratio of MA is determined from the total of the amounts of substance of all the alkali metal elements. In compositional formulas (33a) to (35a), X, Z, A, x, z, and a are the same as in compositional formulas (33) to (35).

MA_{2x+7z}X₂Z₇ (33a)

MA_{2x+7z-a}AX₂Z₇ (34a)

MA_{4x+14z-a}AX₄Z₁₄ (35a)

When the anionic framework has a Ce₂Ni₇-type structure, the ion-conducting species may be an alkaline earth metal element. For example, the solid electrolyte material according to the first embodiment may be represented by any of compositional formulas (33b) to (35b) below in which “MB” denotes an alkaline earth metal element contained as the ion-conducting species. When the ion-conducting species in compositional formulas (33b) to (35b) includes a plurality of alkaline earth metal elements, the compositional ratio of MB is determined from the total of the amounts of substance of all the alkaline earth metal elements. In compositional formulas (33b) to (35b), X, Z, A, x, z, and a are the same as in compositional formulas (33) to (35).

MB_{(2x+7z)/2}X₂Z₇ (33b)

MB_{(2x+7z-a)/2}AX₂Z₇ (34b)

MB_{(4x+14z-a)/2}AX₄Z₁₄ (35b)

Th₂Zn₇-Type Structures

In the solid electrolyte material according to the first embodiment, the anionic framework may have a Th₂Zn₇-type structure.

The solid electrolyte material according to the first embodiment may be a material that includes an anionic framework having a Th₂Zn₇-type structure and is represented by compositional formula (36) below:

Li_{2x+7z}X₂Z₇ (36)

In compositional formula (36), X and Z are anions. X and Z are each independently at least one element selected from the group consisting of Group 14 elements, Group 15 elements, Group 16 elements, and Group 17 elements. The letter x denotes the absolute value of the valence of X. The letter z denotes the absolute value of the valence of Z.

The solid electrolyte material according to the first embodiment may be a material that includes an anionic framework having a Th₂Zn₇-type structure and is represented by compositional formula (37) below:

Li_{2x+7z-a}AX₂Z₇ (37)

In compositional formula (37), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

The solid electrolyte material according to the first embodiment may be a material that includes an anionic framework having a Th₂Zn₇-type structure and is represented by compositional formula (38) below:

Li_{4x+14z-a}AX₄Z₁₄ (38)

In compositional formula (38), A is a cation, and X and Z are anions. X and Z are each independently at least one element selected from the group consisting of Group 14 elements, Group 15 elements, Group 16 elements, and Group 17 elements. A is at least one selected from the group consisting of alkali metal elements except Li, alkaline earth metal elements, transition metal elements, Group 13 elements, Group 14 elements, Group 15 elements, and Group 16 elements. The letter x denotes the absolute value of the valence of X. The letter z denotes the absolute value of the valence of Z. The letter a denotes the absolute value of the valence of A.

While compositional formulas (36) to (38) represent compositions in which the ion-conducting species is lithium, the ion-conducting species for the anionic frameworks having a Th₂Zn₇-type structure is not limited to lithium. For example, the solid electrolyte material according to the first embodiment may be represented by any of compositional formulas (36a) to (38a) below in which “MA” denotes an alkali metal element contained as the ion-conducting species. When the ion-conducting species in compositional formulas (36a) to (38a) includes a plurality of alkali metal elements, the compositional ratio of MA is determined from the total of the amounts of substance of all the alkali metal elements. In compositional formulas (36a) to (38a), X, Z, A, x, z, and a are the same as in compositional formulas (36) to (38).

MA_{2x+7z}X₂Z₇ (36a)

MA_{2x+7z-a}AX₂Z₇ (37a)

MA_{4x+14z-a}AX₄Z₁₄ (38a)

When the anionic framework has a Th₂Zn₇-type structure, the ion-conducting species may be an alkaline earth metal element. For example, the solid electrolyte material according to the first embodiment may be represented by any of compositional formulas (36b) to (38b) below in which “MB” denotes an alkaline earth metal element contained as the ion-conducting species. When the ion-conducting species in compositional formulas (36b) to (38b) includes a plurality of alkaline earth metal elements, the compositional ratio of MB is determined from the total of the amounts of substance of all the alkaline earth metal elements. In compositional formulas (36b) to (38b), X, Z, A, x, z, and a are the same as in compositional formulas (36) to (38).

MB_{(2x+7x)/2}X₂Z₇ (36b)

MB_{(2x+7z-a)/2}AX₂Z₇ (37b)

MB_{(4x+14z-a)/2}AX₄Z₁₄ (38b)

The shape of the solid electrolyte material according to the first embodiment is not limited. Examples of the shapes include acicular, spherical, and ellipsoidal. The solid electrolyte material according to the first embodiment may be particles. The solid electrolyte material according to the first embodiment may have a pellet or plate shape.

When, for example, the solid electrolyte material according to the first embodiment is particles (for example, spherical particles), the solid electrolyte material according to the first embodiment may have a median diameter of greater than or equal to 0.1 μm and less than or equal to 100 μm or may have a median diameter of greater than or equal to 0.5 μm and less than or equal to 10 μm. Such a median diameter ensures that the solid electrolyte material according to the first embodiment and other materials may be favorably dispersed. The median diameter of the particles means the particle size at 50% cumulative volume in the volume-based grain size distribution. For example, the volume-based grain size distribution is measured with a laser diffraction measurement device or an image analyzer.

### Methods for Producing Solid Electrolyte Materials According to First Embodiment

For example, the solid electrolyte material according to the first embodiment is produced by the following method.

When, for example, the desired composition is Li₇NTe₂, a Li₃N ingredient powder and a Li₂Te ingredient powder are mixed so that the Li₃N:Li₂Te molar ratio will be approximately 1:2. The ingredient powders may be mixed in a molar ratio controlled beforehand so as to compensate for compositional changes expected in the synthesis process.

Lithium metal, sulfur, selenium, or tellurium metal may be used as an ingredient.

The mixture of the ingredient powders is reacted with one another mechanochemically in a mixing device, such as a planetary ball mill, to give a reaction product. That is, the ingredient powders are reacted with one another by a mechanochemical milling method. The reaction product may be heat-treated in vacuum or in an inert atmosphere. Alternatively, the mixture of the ingredient powders may be heat-treated in vacuum or in an inert atmosphere to give a reaction product.

The solid electrolyte material according to the first embodiment is obtained by the methods described above.

For example, the composition of the solid electrolyte material can be determined by X-ray photoelectron spectroscopy (XPS).

### Second Embodiment

The second embodiment will be described hereinbelow. The description of features described in the first embodiment may be omitted as appropriate.

A battery according to the second embodiment includes a positive electrode, an electrolyte layer, and a negative electrode. The electrolyte layer is disposed between the positive electrode and the negative electrode. At least one selected from the group consisting of the positive electrode, the electrolyte layer, and the negative electrode contains the solid electrolyte material according to the first embodiment.

The battery according to the second embodiment attains excellent charge-discharge characteristics by virtue of containing the solid electrolyte material according to the first embodiment.

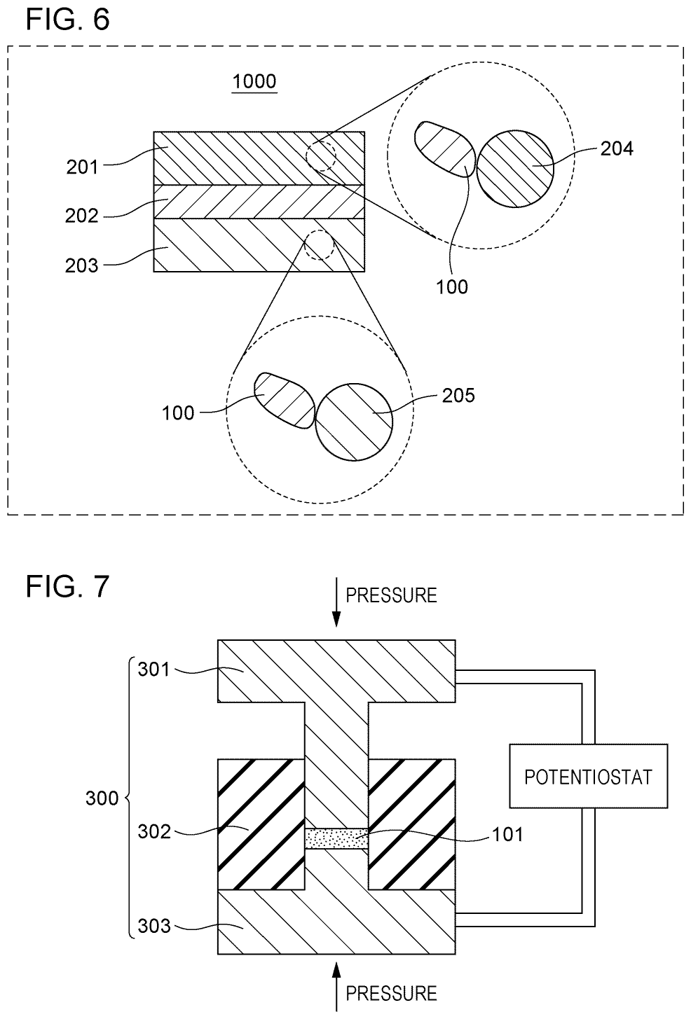

FIG. 6 illustrates a sectional view of a battery 1000 according to the second embodiment.

The battery 1000 includes a positive electrode 201, an electrolyte layer 202, and a negative electrode 203. The electrolyte layer 202 is disposed between the positive electrode 201 and the negative electrode 203.

The positive electrode 201 contains positive electrode active material particles 204 and solid electrolyte particles 100.

The negative electrode 203 contains negative electrode active material particles 205 and solid electrolyte particles 100.

The solid electrolyte particles 100 are particles including the solid electrolyte material according to the first embodiment. The solid electrolyte particles 100 may be particles that include the solid electrolyte material according to the first embodiment as a main component. The phrase that the particles include the solid electrolyte material according to the first embodiment as a main component means that the solid electrolyte material according to the first embodiment represents the highest molar ratio among the components forming the particles. The solid electrolyte particles 100 may be particles consisting of the solid electrolyte material according to the first embodiment.

The positive electrode 201 contains a material capable of occluding and releasing metal ions, such as lithium ions. For example, the material is a positive electrode active material (for example, the positive electrode active material particles 204).

Examples of the positive electrode active materials include lithium-containing transition metal oxides, transition metal fluorides, polyanion materials, fluorinated polyanion materials, transition metal sulfides, transition metal oxyfluorides, transition metal oxysulfides, and transition metal oxynitrides. Examples of the lithium-containing transition metal oxides include Li(Ni,Co,Mn)O₂, Li(Ni,Co,Al)O₂, and LiCoO₂.

In the present disclosure, “(A,B,C)” means “at least one selected from the group consisting of A, B, and C”.

The positive electrode active material particles 204 may have a median diameter of greater than or equal to 0.1 μm and less than or equal to 100 μm. When the positive electrode active material particles 204 have a median diameter of greater than or equal to 0.1 μm, the positive electrode active material particles 204 and the solid electrolyte particles 100 may be favorably dispersed in the positive electrode 201. As a result, charge-discharge characteristics of the battery 1000 are enhanced. When the positive electrode active material particles 204 have a median diameter of less than or equal to 100 μm, the lithium diffusion rate in the positive electrode active material particles 204 is enhanced. Consequently, the battery 1000 may be operated at a high output.

The positive electrode active material particles 204 may have a median diameter larger than that of the solid electrolyte particles 100. With this configuration, the positive electrode active material particles 204 and the solid electrolyte particles 100 may be favorably dispersed.

In order to increase the energy density and the output of the battery 1000, the ratio of the volume of the positive electrode active material particles 204 to the total of the volume of the positive electrode active material particles 204 and the volume of the solid electrolyte particles 100 in the positive electrode 201 may be greater than or equal to 0.30 and less than or equal to 0.95.

In order to increase the energy density and the output of the battery 1000, the positive electrode 201 may have a thickness of greater than or equal to 10 μm and less than or equal to 500 μm.

The electrolyte layer 202 contains an electrolyte material. For example, the electrolyte material is a solid electrolyte material. The electrolyte layer 202 may be a solid electrolyte layer. The electrolyte layer 202 may contain the solid electrolyte material according to the first embodiment.

The electrolyte layer 202 may include greater than or equal to 50 mass % of the solid electrolyte material according to the first embodiment. The electrolyte layer 202 may include greater than or equal to 70 mass % of the solid electrolyte material according to the first embodiment. The electrolyte layer 202 may include greater than or equal to 90 mass % of the solid electrolyte material according to the first embodiment. The electrolyte layer 202 may consist solely of the solid electrolyte material according to the first embodiment.

Hereinafter, the solid electrolyte material according to the first embodiment is written as the first solid electrolyte material. A solid electrolyte material different from the first solid electrolyte material is written as the second solid electrolyte material.

The electrolyte layer 202 may contain not only the first solid electrolyte material but also the second solid electrolyte material. In the electrolyte layer 202, the first solid electrolyte material and the second solid electrolyte material may be uniformly dispersed. A layer consisting of the first solid electrolyte material and a layer consisting of the second solid electrolyte material may be stacked in the stacking direction of the battery 1000.

The electrolyte layer 202 may consist solely of the second solid electrolyte material.

The electrolyte layer 202 may have a thickness of greater than or equal to 1 μm and less than or equal to 1000 μm. When the electrolyte layer 202 has a thickness of greater than or equal to 1 μm, the positive electrode 201 and the negative electrode 203 are unlikely to be short-circuited. When the electrolyte layer 202 has a thickness of less than or equal to 1000 μm, the battery 1000 may be operated at a high output.

The negative electrode 203 contains a material capable of occluding and releasing metal ions, such as lithium ions. For example, the material is a negative electrode active material (for example, the negative electrode active material particles 205).

Examples of the negative electrode active materials include metal materials, carbon materials, oxides, nitrides, tin compounds, and silicon compounds. The metal materials may be elemental metals or alloys. Examples of the metal materials include lithium metal and lithium alloys. Examples of the carbon materials include natural graphites, cokes, semi-graphitized carbons, carbon fibers, spherical carbons, artificial graphites, and amorphous carbons. From the point of view of capacitance density, for example, silicon (that is, Si), tin (that is, Sn), silicon compounds, and tin compounds are preferable as the negative electrode active materials.

The negative electrode active material particles 205 may have a median diameter of greater than or equal to 0.1 μm and less than or equal to 100 μm. When the negative electrode active material particles 205 have a median diameter of greater than or equal to 0.1 μm, the negative electrode active material particles 205 and the solid electrolyte particles 100 may be favorably dispersed in the negative electrode 203. As a result, charge-discharge characteristics of the battery 1000 are enhanced. When the negative electrode active material particles 205 have a median diameter of less than or equal to 100 lam, the lithium diffusion rate in the negative electrode active material particles 205 is enhanced. Consequently, the battery 1000 may be operated at a high output.

The negative electrode active material particles 205 may have a median diameter larger than that of the solid electrolyte particles 100. With this configuration, the negative electrode active material particles 205 and the solid electrolyte particles 100 may be favorably dispersed.

In order to increase the energy density and the output of the battery 1000, the ratio of the volume of the negative electrode active material particles 205 to the total of the volume of the negative electrode active material particles 205 and the volume of the solid electrolyte particles 100 in the negative electrode 203 may be greater than or equal to 0.30 and less than or equal to 0.95.

In order to increase the energy density and the output of the battery 1000, the negative electrode 203 may have a thickness of greater than or equal to 10 μm and less than or equal to 500 μm.

At least one selected from the group consisting of the positive electrode 201, the electrolyte layer 202, and the negative electrode 203 may contain the second solid electrolyte material for the purpose of enhancing ion conductivity, chemical stability, and electrochemical stability.

The second solid electrolyte material may be a halide solid electrolyte.

Examples of the halide solid electrolytes include Li₂MgX′₄, Li₂FeX′₄, Li(Al,Ga,In)X′₄, and Li₃(Al,Ga,In)X′₆. Here, X′ is at least one selected from the group consisting of F, Cl, Br, and I.

Examples of the halide solid electrolytes further include compounds represented by LiₚMe_{q}YᵣZ₆. Here, p+m′q+3r=6 and r>0 are satisfied. Me is at least one element selected from the group consisting of metal elements except Li and Y, and metalloid elements. The value of m′ indicates the valence of Me. The “metalloid elements” are B, Si, Ge, As, Sb, and Te. The “metal elements” are all the elements in Groups 1 to 12 of the periodic table (except hydrogen), and all the elements in Groups 13 to 16 of the periodic table (except B, Si, Ge, As, Sb, Te, C, N, P, O, S, and Se). Z is at least one selected from the group consisting of F, Cl, Br, and I. From the point of view of the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The second solid electrolyte material may be a sulfide solid electrolyte.

Examples of the sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

The second solid electrolyte material may be an oxide solid electrolyte.

Examples of the oxide solid electrolytes include:
(i) NASICON-type solid electrolytes, such as LiTi₂(PO₄)₃ and element-substituted derivatives thereof,
(ii) perovskite-type solid electrolytes, such as (LaLi)TiO₃,
(iii) LISICON-type solid electrolytes, such as Li₁₄ZnGe₄O₁₆, Li₄SiO₄, LiGeO₄, and element-substituted derivatives thereof,
(iv) garnet-type solid electrolytes, such as Li₇La₃Zr₂O₁₂ and element-substituted derivatives thereof, and
(v) Li₃PO₄ and N-substituted derivatives thereof.

The second solid electrolyte material may be an organic polymeric solid electrolyte.

Examples of the organic polymeric solid electrolytes include compounds of a polymer compound and a lithium salt. The polymer compound may have an ethylene oxide structure. The polymer compound having an ethylene oxide structure can contain a large amount of the lithium salt, and thus the ionic conductivity can be further increased.

Examples of the lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. A single kind of a lithium salt selected from these may be used singly. Alternatively, a mixture of two or more kinds of lithium salts selected from the above may be used.

At least one selected from the group consisting of the positive electrode 201, the electrolyte layer 202, and the negative electrode 203 may contain a nonaqueous electrolyte solution, a gel electrolyte, or an ionic liquid for the purposes of facilitating the transfer of lithium ions and enhancing output characteristics of the battery 1000.

The nonaqueous electrolyte solution includes a nonaqueous solvent and a lithium salt dissolved in the nonaqueous solvent.

Examples of the nonaqueous solvents include cyclic carbonate ester solvents, chain carbonate ester solvents, cyclic ether solvents, chain ether solvents, cyclic ester solvents, chain ester solvents, and fluorine solvents. Examples of the cyclic carbonate ester solvents include ethylene carbonate, propylene carbonate, and butylene carbonate. Examples of the chain carbonate ester solvents include dimethyl carbonate, ethyl methyl carbonate, and diethyl carbonate. Examples of the cyclic ether solvents include tetrahydrofuran, 1,4-dioxane, and 1,3-dioxolane. Examples of the chain ether solvents include 1,2-dimethoxyethane and 1,2-diethoxyethane. Examples of the cyclic ester solvents include γ-butyrolactone. Examples of the chain ester solvents include methyl acetate. Examples of the fluorine solvents include fluoroethylene carbonate, methyl fluoropropionate, fluorobenzene, fluoroethyl methyl carbonate, and fluorodimethylene carbonate. A single kind of a nonaqueous solvent selected from these may be used singly. Alternatively, a mixture of two or more kinds of nonaqueous solvents selected from the above may be used.

Examples of the lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. A single kind of a lithium salt selected from these may be used singly. Alternatively, a mixture of two or more kinds of lithium salts selected from the above may be used. For example, the concentration of the lithium salt is greater than or equal to 0.5 mol/L and less than or equal to 2 mol/L.

The gel electrolyte may be a polymer material impregnated with a nonaqueous electrolyte solution. Examples of the polymer materials include polyethylene oxide, polyacrylonitrile, polyvinylidene fluoride, polymethyl methacrylate, and polymers having ethylene oxide bonds.

Examples of the cations contained in the ionic liquids include:
(i) aliphatic chain quaternary salts, such as tetraalkyl ammoniums and tetraalkyl phosphoniums,
(ii) aliphatic cyclic ammoniums, such as pyrrolidiniums, morpholiniums, imidazoliniums, tetrahydropyrimidiniums, piperaziniums, and piperidiniums, and
(iii) nitrogen-containing heterocyclic aromatic cations, such as pyridiniums and imidazoliums.

Examples of the anions contained in the ionic liquids include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of enhancing the adhesion between the particles.

Examples of the binders include polyvinylidene fluoride, polytetrafluoroethylene, polyethylene, polypropylene, aramid resins, polyamide, polyimide, polyamidimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethylcellulose. Copolymers may also be used as the binders. Examples of such binders include copolymers of two or more kinds of materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more kinds of materials selected from the above may be used as the binder.

At least one selected from the positive electrode 201 and the negative electrode 203 may contain a conductive auxiliary for the purpose of enhancing the electron conductivity.

Examples of the conductive auxiliaries include:
(i) graphites, such as natural graphites and artificial graphites,
(ii) carbon blacks, such as acetylene blacks and Ketjen blacks,
(iii) conductive fibers, such as carbon fibers and metal fibers,
(iv) carbon fluoride,
(v) metal powders, such as aluminum,
(vi) conductive whiskers, such as zinc oxide and potassium titanate,
(vii) conductive metal oxides, such as titanium oxide, and
(viii) conductive polymer compounds, such as polyaniline, polypyrrole, and polythiophene.

To reduce the cost, a conductive auxiliary belonging to (i) or (ii) may be used.

Examples of the shapes of the batteries according to the second embodiment include coin shapes, cylindrical shapes, prismatic shapes, sheet shapes, button shapes, flat shapes, and laminate shapes.

For example, the battery according to the second embodiment may be produced by providing materials for forming the positive electrode, materials for forming the electrolyte layer, and materials for forming the negative electrode, and fabricating by a known method a stack in which the positive electrode, the electrolyte layer, and the negative electrode are arranged in this order.

### EXAMPLES

The present disclosure will be described in greater detail hereinbelow with reference to EXAMPLES.

### Example 1

### Preparation of Li₂Te

In an argon atmosphere having a dew point of less than or equal to −60° C. (hereinafter, written as “dry argon atmosphere”), Li and Te as ingredient powders were provided so that the molar ratio Li:Te would be 2.5:1. These ingredient powders were crushed and mixed together in a mortar. A mixed powder was thus obtained. The mixed powder was heat-treated in a dry argon atmosphere at 500° C. for 1 hour. The resultant powder was crushed in a mortar. Li₂Te powder was thus obtained.

### Preparation of Solid Electrolyte Material

In a dry argon atmosphere, Li₃N (manufactured by Sigman Aldrich) and Li₂Te as ingredient powders were provided so that the molar ratio Li₃N:Li₂Te would be 1:2. These ingredient powders were crushed and mixed together in a mortar. A mixed powder was thus obtained. The mixed powder was milled with a planetary ball mill at 500 rpm for 12 hours. A powder of a solid electrolyte material according to EXAMPLE 1 was thus obtained. The solid electrolyte material according to EXAMPLE 1 had a composition represented by Li₇NTe₂.

The contents of Li, Te, and N per unit mass of the solid electrolyte material according to EXAMPLE 1 were measured by XPS. Based on the contents of Li, Te, and N obtained by the measurement, the molar ratio Li:Te:N was calculated. As a result, the solid electrolyte material according to EXAMPLE 1 had a molar ratio Li:Te:N of 7:2:1 in consistency with the molar ratio of the ingredient powders provided.

### Experimental Evaluation of Ionic Conductivity

FIG. 7 is a schematic view illustrating a pressure forming die 300 used to evaluate the ionic conductivity of the solid electrolyte material.

The pressure forming die 300 included an upper punch 301, a die 302, and a lower punch 303. The upper punch 301 and the lower punch 303 were each formed of electron-conductive stainless steel. The die 302 was formed of an insulating polycarbonate.

Using the pressure forming die 300 illustrated in FIG. 7, the ionic conductivity of the solid electrolyte material according to EXAMPLE 1 was evaluated by the following method.

In a dry atmosphere having a dew point of less than or equal to −30° C., the powder of the solid electrolyte material according to EXAMPLE 1 (the powder 101 of the solid electrolyte material in FIG. 7) was charged to fill the inside of the pressure forming die 300. Inside the pressure forming die 300, a pressure of 300 MPa was applied to the solid electrolyte material according to EXAMPLE 1 using the upper punch 301 and the lower punch 303.

While maintaining the pressure, the upper punch 301 and the lower punch 303 were connected to a potentiostat (Princeton Applied Research, Versa STAT 4) equipped with a frequency response analyzer. The upper punch 301 was connected to the working electrode and the potential measuring terminal. The lower punch 303 was connected to the counter electrode and the reference electrode. The impedance of the solid electrolyte material was measured at room temperature by an electrochemical impedance measurement method.

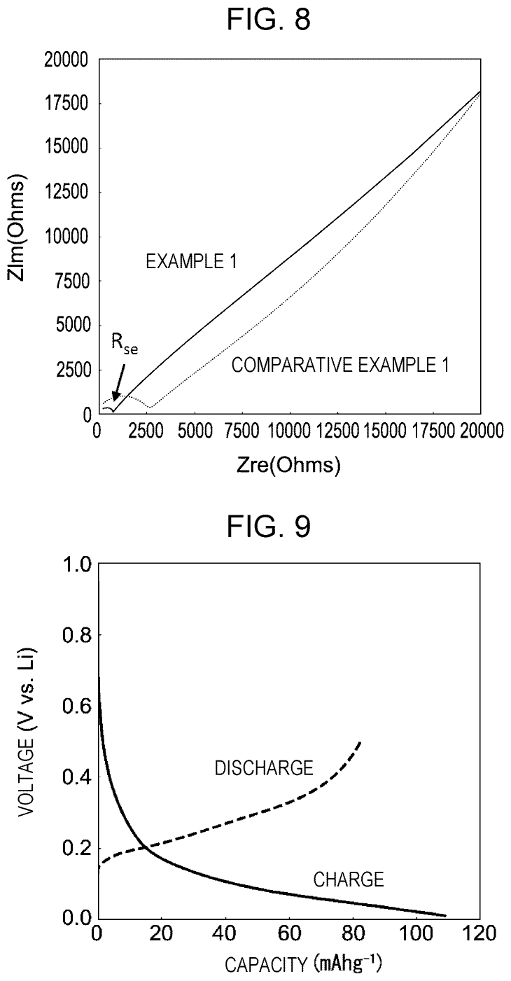

FIG. 8 is a graph illustrating the Cole-Cole plot obtained by the impedance measurement of the solid electrolyte material according to EXAMPLE 1.

In FIG. 8, the real value of impedance at the measurement point where the absolute value of the complex impedance phase was smallest was taken as the value of resistance of the solid electrolyte material to ion conduction. For the real value, refer to the arrow Rₛₑ illustrated in FIG. 8. Using the resistance value, the ionic conductivity was calculated based on equation (39) below:

σ=(Rₛₑ×S/t)⁻¹ (39)

Here, σ indicates the ionic conductivity. S represents the area of contact between the solid electrolyte material and the upper punch 301. The area S is equal to the sectional area of the hollow portion of the die 302 in FIG. 7. Rₛₑ indicates the resistance value of the solid electrolyte material in the impedance measurement. The letter t indicates the thickness of the solid electrolyte material (specifically, the thickness of the layer formed of the powder 101 of the solid electrolyte material in FIG. 7).

The ionic conductivity of the solid electrolyte material according to EXAMPLE 1 measured at 22° C. was 7.6×10⁻⁵ S/cm.

### Fabrication of Battery

In a dry argon atmosphere, the solid electrolyte material according to EXAMPLE 1 and graphite were provided in a volume ratio of 1:1. These materials were mixed together in a mortar to give a mixture.

In an insulating cylinder having an inner diameter of 9.5 mm, argyrodite-type sulfide solid electrolyte Li₆PS₅Cl (100 mg), the solid electrolyte material (30 mg) according to EXAMPLE 1, and the above mixture were stacked in this order. The mixture used here contained 4 mg of the graphite. A pressure of 740 MPa was applied to the resultant stack to form a solid electrolyte layer and a first electrode.

Next, a metallic In foil, a metallic Li foil, and a metallic In foil were stacked in this order onto the solid electrolyte layer. A pressure of 40 MPa was applied to the resultant stack to form a second electrode.

Next, current collectors formed of stainless steel were attached to the first electrode and the second electrode, and current collector leads were attached to the current collectors.

Lastly, the inside of the insulating cylinder was isolated from the outside atmosphere with use of an insulating ferrule. The inside of the cylinder was thus sealed. A battery according to EXAMPLE 1 was thus obtained.

### Charge-Discharge Test

FIG. 9 is a graph illustrating initial discharge characteristics of the battery according to EXAMPLE 1. Initial charge-discharge characteristics were measured by the following method. The battery fabricated in EXAMPLE 1 is a charge-discharge test cell and corresponds to a negative electrode half-cell. Thus, in EXAMPLE 1, the direction in which lithium ions are inserted into the negative electrode and the potential of the half-cell decreases is defined as charging, and the direction in which the potential increases is referred to as discharging. That is, charging in EXAMPLE 1 is essentially (that is, in the case of a full cell) discharging, and discharging in EXAMPLE 1 is essentially charging.

The battery according to EXAMPLE 1 was placed in a thermostatic chamber at 25° C.

The battery according to EXAMPLE 1 was charged at a current density of 74.5 μA/cm² until the voltage reached 0.0 V. This current density corresponds to 0.05 C rate.

Next, the battery according to EXAMPLE 1 was discharged at a current density of 74.5 μA/cm² until the voltage reached 0.5 V.

As a result of the charge-discharge test, the battery according to EXAMPLE 1 had an initial discharge capacity of 82 mAh.

### Computational Evaluation of Synthesizability

Li₇NTe₂ models having an Al₂Cu-type tetrahedral composite structure were created and the convex hull energies were calculated by ab initio calculation to evaluate the synthesizability.

In the models, Al atoms and Cu atoms in the crystal structure of Al₂Cu were substituted with Te atoms and N atoms, respectively. In the models, Li atoms were arranged randomly at the center of tetrahedrons consisting of Te atoms and N atoms so that the molar ratio Li:Te:N would be 7:2:1. One hundred such randomly arranged models were created. By ab initio calculation, structural relaxation was performed, and the total energies were calculated. The model with the lowest energy was obtained as Al₂Cu-type Li₇NTe₂. The crystal structure obtained is illustrated in FIG. 10. FIG. 10 illustrates the crystal structure of the solid electrolyte material according to EXAMPLE 1 optimized by ab initio calculation. Incidentally, VASP code was used for the ab initio calculation.

Next, the convex hull energy of the Al₂Cu-type Li₇NTe₂ model was calculated by ab initio calculation. The convex hull energy is an indicator of the stability of a phase of interest relative to other phases (competing phases). The competing phases considered here were compounds found in the database of The Materials Project (https://materialsproject.org/). Thermodynamically, Li₇NTe₂ coexists with Li₈TeN₂ and Li₂Te, that is, Li₈TeN₂ and Li₂Te are competing phases. Thus, the convex hull energy was calculated from equation (40) below:

Eₕᵤₗₗ(Li₇NTe₂)=Eₜₒₜ(Li₇NTe₂)−3/4Eₜₒₜ(Li₂Te)−1/4Eₜₒₜ(Li₈TeN₂) (40)

Here, Eₕᵤₗₗ (Li₇NTe₂) indicates the convex hull energy per unit atom of Li₇NTe₂. Eₜₒₜ (Li₇NTe₂), Eₜₒₜ (Li₈TeN₂), and Eₜₒₜ (Li₂Te) indicate the total energies per unit atom of Li₇NTe₂, Li₈TeN₂, and Li₂Te, respectively. If the value is below zero, the convex hull energy is zero. A value of convex hull energy closer to zero indicates higher thermodynamic stability.

### Computational Evaluation of Ionic Conductivity

The ionic conductivity of the Al₂Cu-type Li₇NTe₂ model obtained by the above method was evaluated by ab initio molecular dynamics calculation. A canonical ensemble was constructed in accordance with the Nose algorithm by calculation of 35000 steps for 2 fs per step at temperatures of 500, 600, 650, 700, 750, and 800 K. The diffusion coefficient obtained was linearly extrapolated as a function of the reciprocal of the temperature, and the ionic conductivity a was calculated from the diffusion coefficient D at room temperature by equation (41) below. Any points that deviated significantly from the trend during the linear extrapolation were removed. “No conduction” means that the ions did not diffuse and the diffusion coefficient could not be calculated. FIG. 42 is a graph illustrating the temperature dependence of the Li ion diffusion coefficient of the solid electrolyte material according to EXAMPLE 1 calculated by ab initio molecular dynamics calculation. Incidentally, VASP code was used for the ab initio calculation.

σ=(ze)₂nD/kT (41)

Here, ze indicates the amount of charges. The letter n indicates the lithium ion density. The letter k indicates the Boltzmann constant. The letter T indicates the temperature.

### Experimental Analysis of Crystal Structure

In order to identify the crystal structure of the solid electrolyte material according to EXAMPLE 1, X-ray diffractometry (XRD) was performed. Cu-Kα radiation was used as X-ray. The measurement was carried out in a dry argon atmosphere.

FIG. 74 is a graph illustrating the X-ray diffraction pattern of the solid electrolyte material according to EXAMPLE 1. The abscissa indicates 20, and the ordinate indicates the X-ray diffraction intensity. The dotted-line pattern is the computationally predicted X-ray diffraction pattern (that is, the simulation peaks) of Al₂Cu-type Li₇NTe₂. The agreement of the X-ray diffraction pattern of the solid electrolyte material according to EXAMPLE 1 with the simulation peaks of Al₂Cu-type Li₇NTe₂ suggested that the solid electrolyte material according to EXAMPLE 1 had an Al₂Cu-type structure.

### Examples 2 to 4

### Preparation of Solid Electrolyte Materials

In EXAMPLE 2, Li₃N and Li₂Te were provided as ingredient powders so that the molar ratio Li₃N:Li₂Te would be 1:3.

In EXAMPLE 3, Li₃N and Li₂Te were provided as ingredient powders so that the molar ratio Li₃N:Li₂Te would be 3:7.

In EXAMPLE 4, Li₂Se was used as an ingredient powder instead of Li₂Te. Li₃N and Li₂Se were provided so that the molar ratio Li₃N:Li₂Se would be 1:2.

Solid electrolyte materials according to EXAMPLES 2 to 4 were obtained in the same manner as in EXAMPLE 1 except for the above differences.

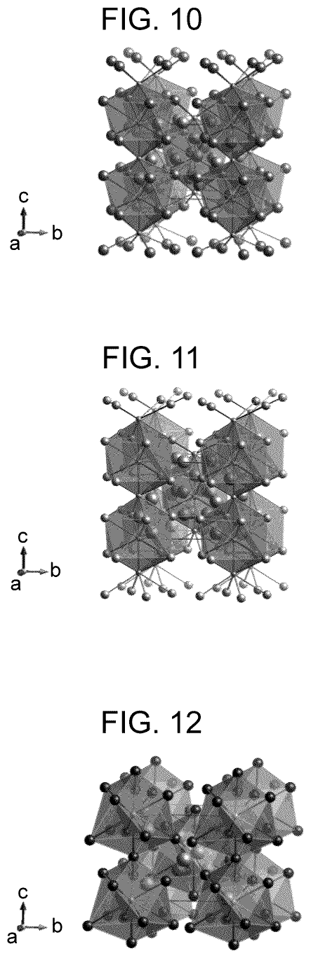

FIG. 11 is a view illustrating a crystal structure of the solid electrolyte material according to EXAMPLE 4 optimized by ab initio calculation.

### Experimental Evaluation of Ionic Conductivity

The ionic conductivity of the solid electrolyte materials according to EXAMPLES 2 to 4 was measured in the same manner as in EXAMPLE 1. The measurement results are described in Table 2.

### Computational Evaluation of Ionic Conductivity

The ionic conductivity of the solid electrolyte material according to EXAMPLE 4 was computationally evaluated in the same manner as in EXAMPLE 1. FIG. 43 is a graph illustrating the temperature dependence of the Li ion diffusion coefficient of the solid electrolyte material according to EXAMPLE 4 calculated by ab initio molecular dynamics calculation.

### Charge-Discharge Test

Batteries according to EXAMPLES 2 to 4 were obtained in the same manner as in EXAMPLE 1 using the solid electrolyte materials according to EXAMPLES 2 to 4. The batteries according to EXAMPLES 2 to 4 were charged and discharged favorably similarly to the battery according to EXAMPLE 1.

### Examples 5 to 32

Models were created for the compounds described below, and the convex hull energies were calculated by ab initio calculation in the same manner as in EXAMPLE 1.

In the model generation, 50 types of structural models were created by substituting the base tetrahedral composite structure with anions and arranging Li atoms and cations in tetrahedral sites of the structure. The most stable structure was extracted by ab initio calculation.

Furthermore, the diffusion coefficient was calculated and the ionic conductivity was evaluated in the same manner as in EXAMPLE 1.

### Examples 5 to 8

Solid electrolyte materials according to EXAMPLES 5 to 8 are Li₈Br₅N, Li₈I₅N, Li₃ZnS₂F, and Li₃MgSe₂F each having an Al₂Cu-type tetrahedral composite structure.

FIG. 12 is a view illustrating a crystal structure of the solid electrolyte material according to EXAMPLE 5 optimized by ab initio calculation.

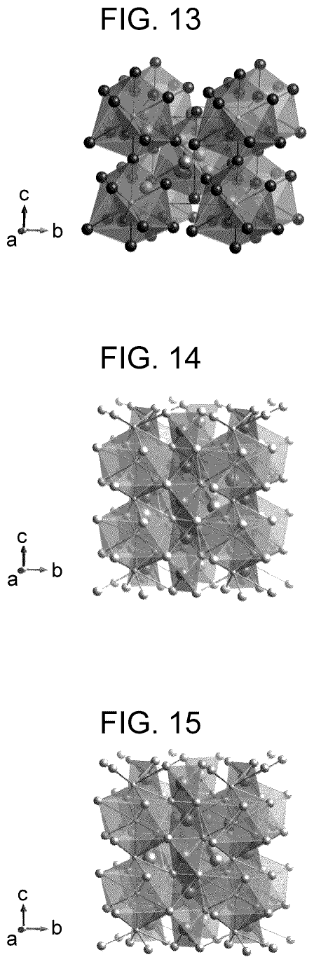

FIG. 13 is a view illustrating a crystal structure of the solid electrolyte material according to EXAMPLE 6 optimized by ab initio calculation.

FIG. 14 is a view illustrating a crystal structure of the solid electrolyte material according to EXAMPLE 7 optimized by ab initio calculation.

FIG. 15 is a view illustrating a crystal structure of the solid electrolyte material according to EXAMPLE 8 optimized by ab initio calculation.

FIG. 44 is a graph illustrating the temperature dependence of the Li ion diffusion coefficient of the solid electrolyte material according to EXAMPLE 5 calculated by ab initio molecular dynamics calculation.

FIG. 45 is a graph illustrating the temperature dependence of the Li ion diffusion coefficient of the solid electrolyte material according to EXAMPLE 6 calculated by ab initio molecular dynamics calculation.

FIG. 46 is a graph illustrating the temperature dependence of the Li ion diffusion coefficient of the solid electrolyte material according to EXAMPLE 7 calculated by ab initio molecular dynamics calculation.

FIG. 47 is a graph illustrating the temperature dependence of the Li ion diffusion coefficient of the solid electrolyte material according to EXAMPLE 8 calculated by ab initio molecular dynamics calculation.

### Examples 9 to 12

Solid electrolyte materials according to EXAMPLES 9 to 12 are Li₁₅Te₆N, Li₆Pb₂O₃Cl₄, Li₄Al₂Se₃I₄, and Li₄In₂S₃I₄ each having a Zr₄Al₃-type tetrahedral composite structure.

FIG. 16 is a view illustrating a crystal structure of the solid electrolyte material according to EXAMPLE 9 optimized by ab initio calculation.

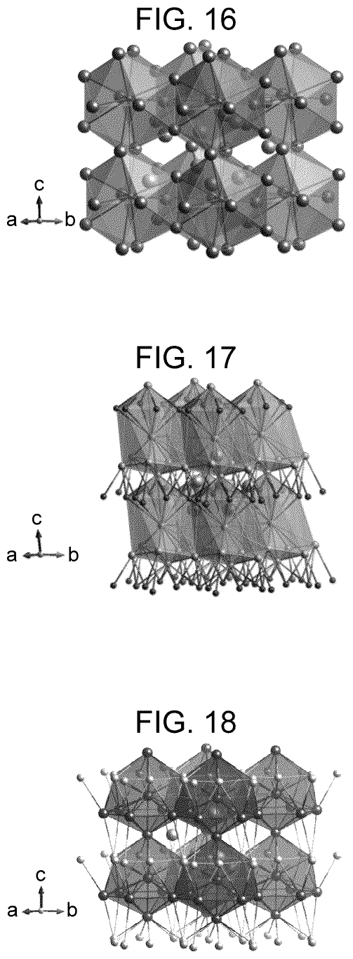

FIG. 17 is a view illustrating a crystal structure of the solid electrolyte material according to EXAMPLE 10 optimized by ab initio calculation.

FIG. 18 is a view illustrating a crystal structure of the solid electrolyte material according to EXAMPLE 11 optimized by ab initio calculation.

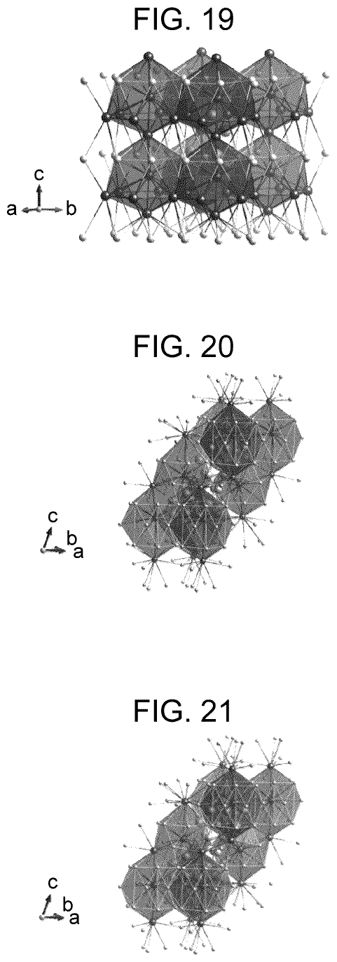

FIG. 19 is a view illustrating a crystal structure of the solid electrolyte material according to EXAMPLE 12 optimized by ab initio calculation.

FIG. 48 is a graph illustrating the temperature dependence of the Li ion diffusion coefficient of the solid electrolyte material according to EXAMPLE 9 calculated by ab initio molecular dynamics calculation.

FIG. 49 is a graph illustrating the temperature dependence of the Li ion diffusion coefficient of the solid electrolyte material according to EXAMPLE 10 calculated by ab initio molecular dynamics calculation.

FIG. 50 is a graph illustrating the temperature dependence of the Li ion diffusion coefficient of the solid electrolyte material according to EXAMPLE 11 calculated by ab initio molecular dynamics calculation.

FIG. 5I is a graph illustrating the temperature dependence of the Li ion diffusion coefficient of the solid electrolyte material according to EXAMPLE 12 calculated by ab initio molecular dynamics calculation.

### Examples 13 to 26

Solid electrolyte materials according to EXAMPLES 13 to 26 were Li₁₀BrN₃, Li₁₀IN₃, Li₁₁SeN₃, Li₁₁TeN₃, Li₂₉Zn₂(SeN₃)₃, Li₂₉Zn₂(TeN₃)₃, Li₂₉Mg₂(SeN₃)₃, Li₂₉Mg₂(TeN₃)₃, Li₂₅Si₂(TeP₃)₃, Li₂₅Ge₂(SN₃)₃, Li₂₅Sn₂(TeN₃)₃, Li₂₄Ga₂(IN₃)₃, Li₂₄In₂(IN₃)₃, and Li₂₇Al₂ (TeP₃)₃ each having a NbBe₃-type tetrahedral composite structure.

FIG. 20 is a view illustrating a crystal structure of the solid electrolyte material according to EXAMPLE 13 optimized by ab initio calculation.

FIG. 21 is a view illustrating a crystal structure of the solid electrolyte material according to EXAMPLE 14 optimized by ab initio calculation.

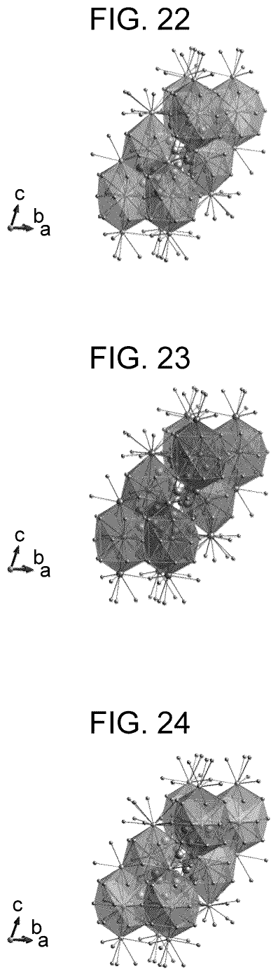

FIG. 22 is a view illustrating a crystal structure of the solid electrolyte material according to EXAMPLE 15 optimized by ab initio calculation.

FIG. 23 is a view illustrating a crystal structure of the solid electrolyte material according to EXAMPLE 16 optimized by ab initio calculation.

FIG. 24 is a view illustrating a crystal structure of the solid electrolyte material according to EXAMPLE 17 optimized by ab initio calculation.

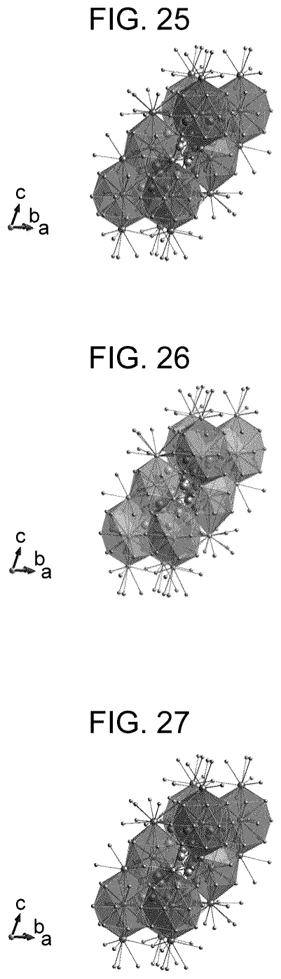

FIG. 25 is a view illustrating a crystal structure of the solid electrolyte material according to EXAMPLE 18 optimized by ab initio calculation.

FIG. 26 is a view illustrating a crystal structure of the solid electrolyte material according to EXAMPLE 19 optimized by ab initio calculation.

FIG. 27 is a view illustrating a crystal structure of the solid electrolyte material according to EXAMPLE 20 optimized by ab initio calculation.

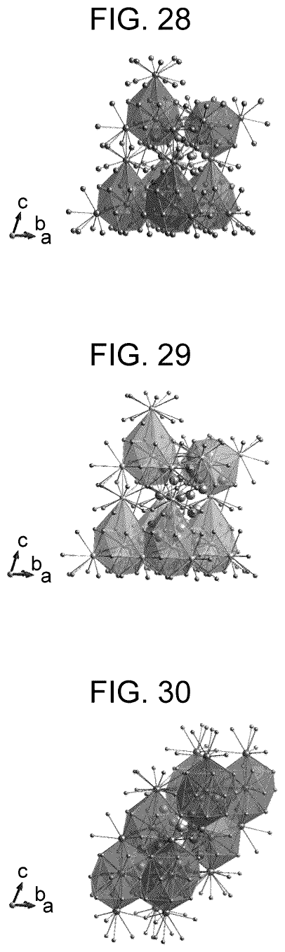

FIG. 28 is a view illustrating a crystal structure of the solid electrolyte material according to EXAMPLE 21 optimized by ab initio calculation.

FIG. 29 is a view illustrating a crystal structure of the solid electrolyte material according to EXAMPLE 22 optimized by ab initio calculation.

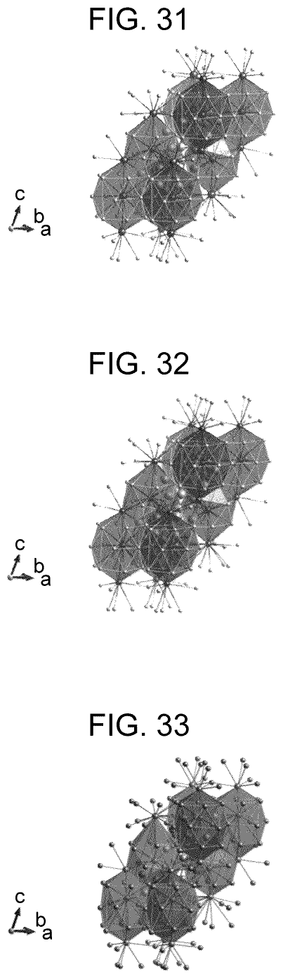

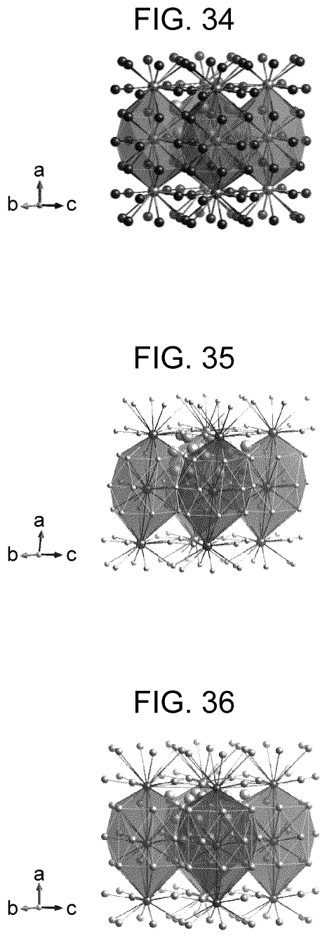

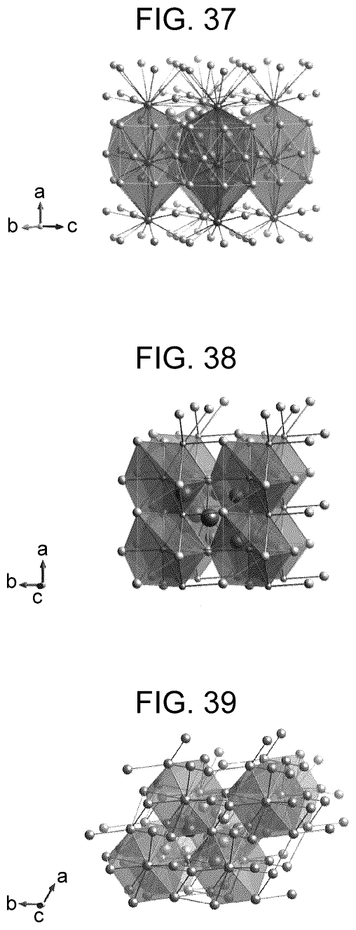

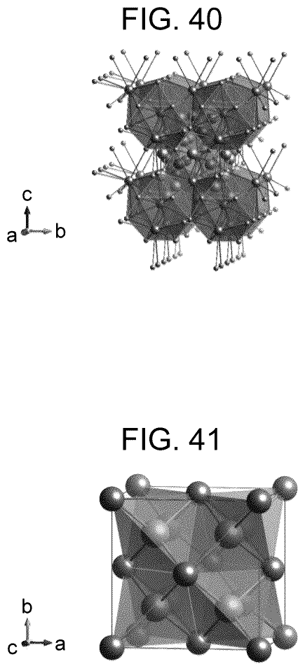

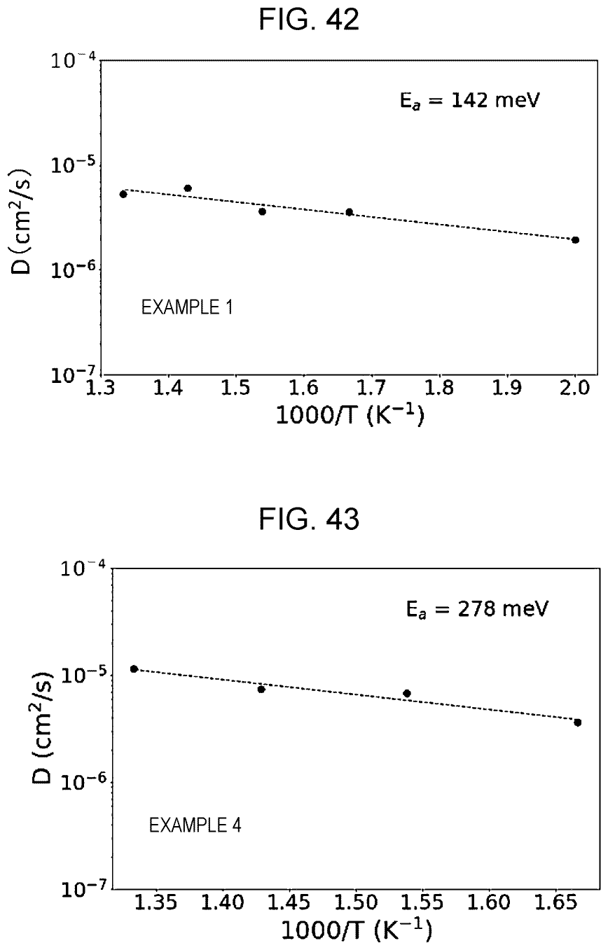

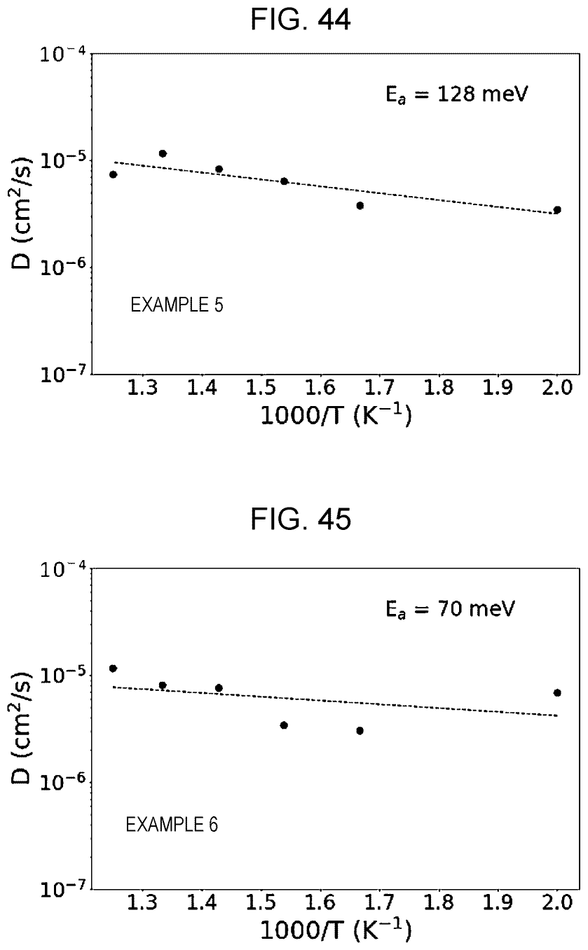

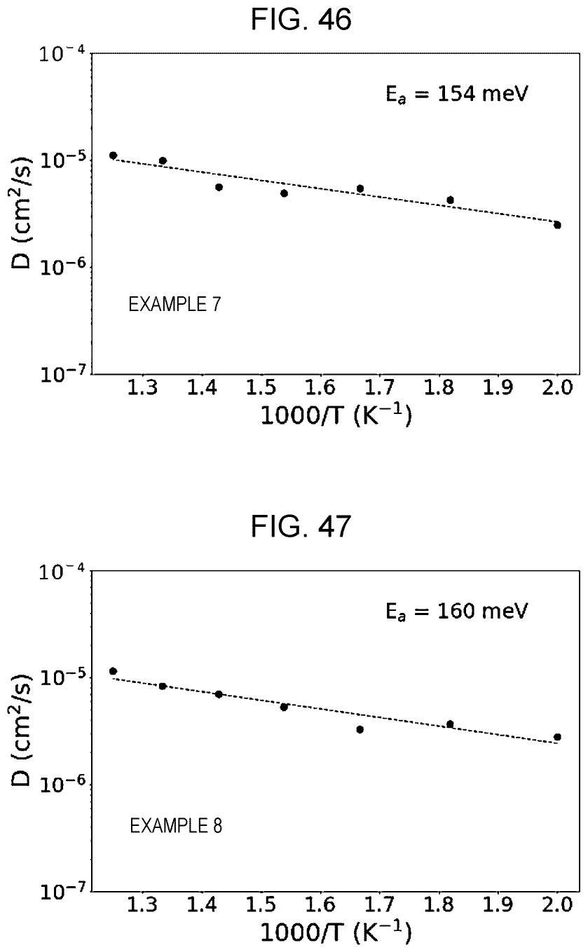

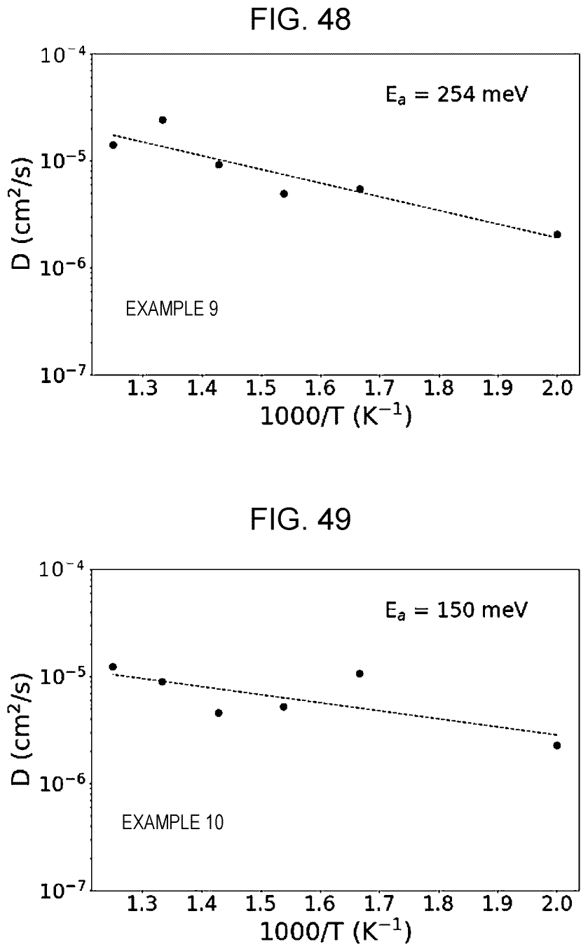

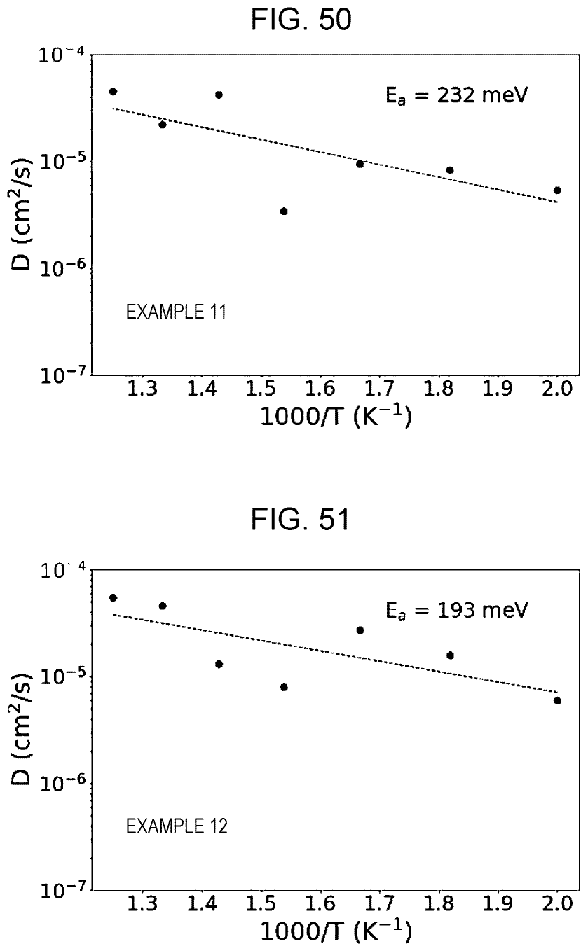

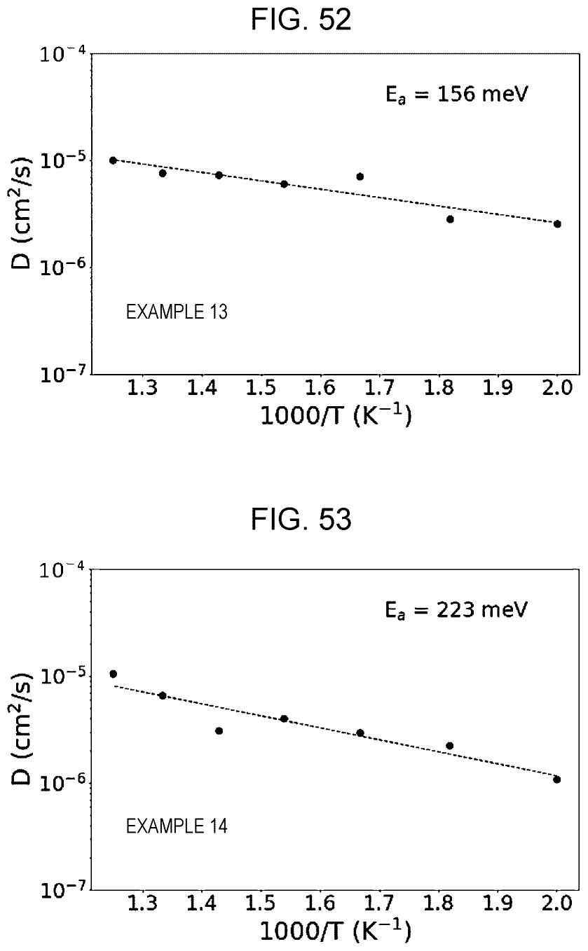

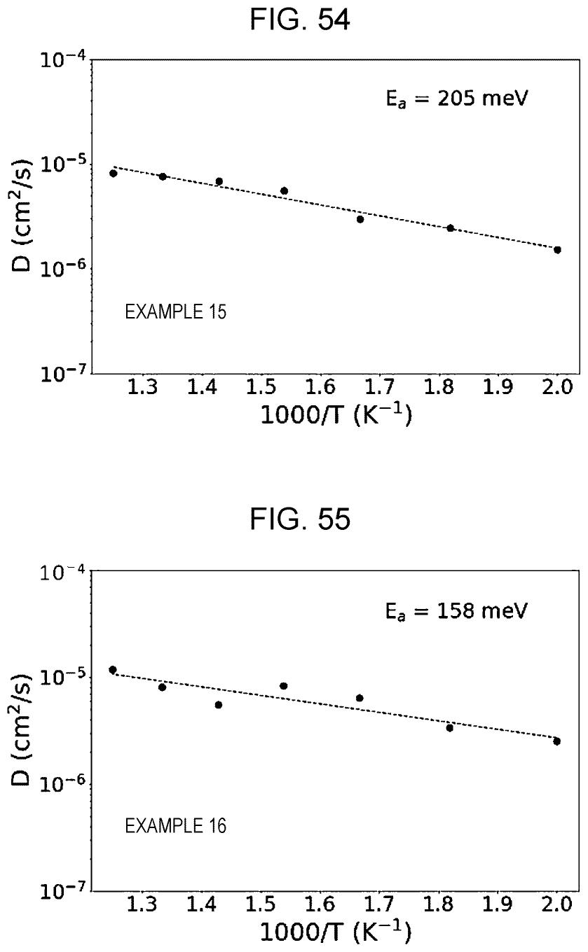

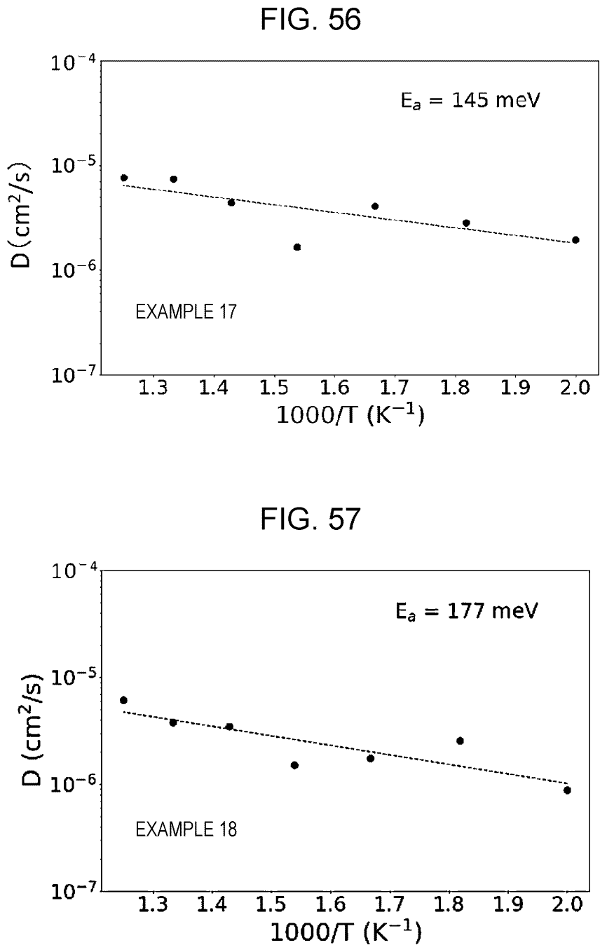

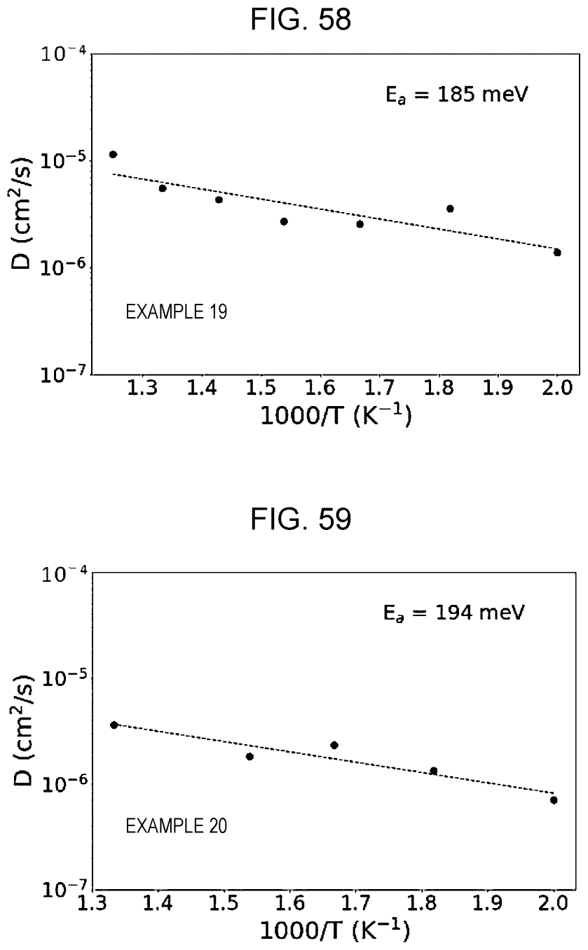

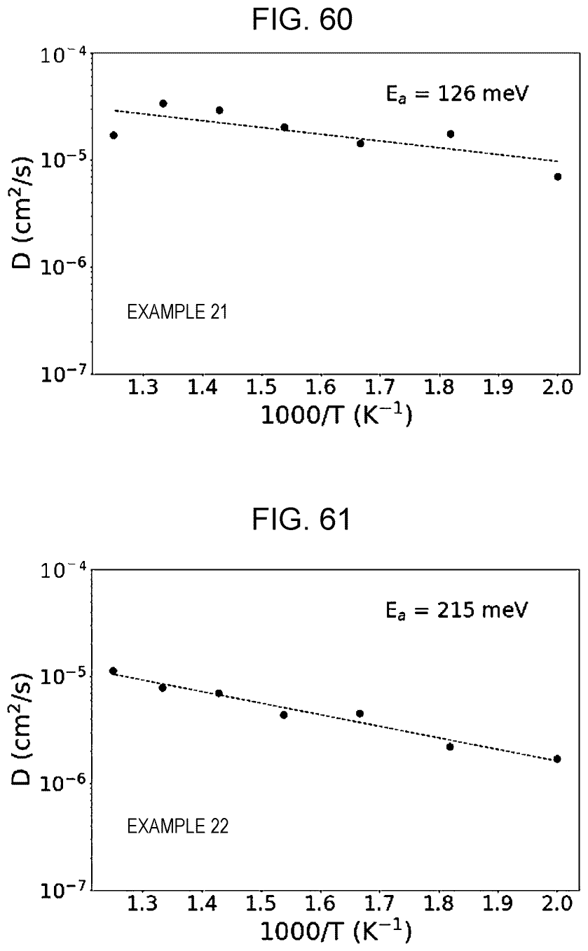

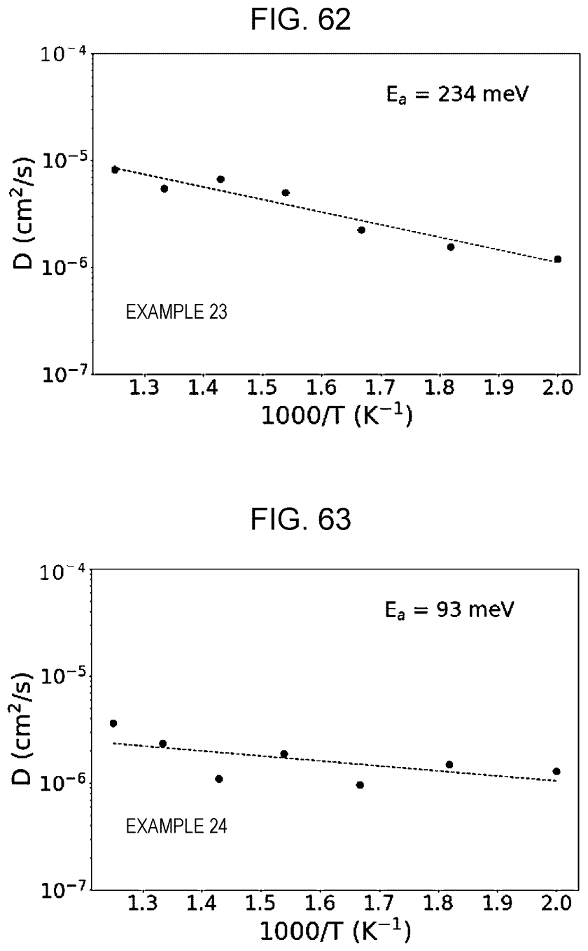

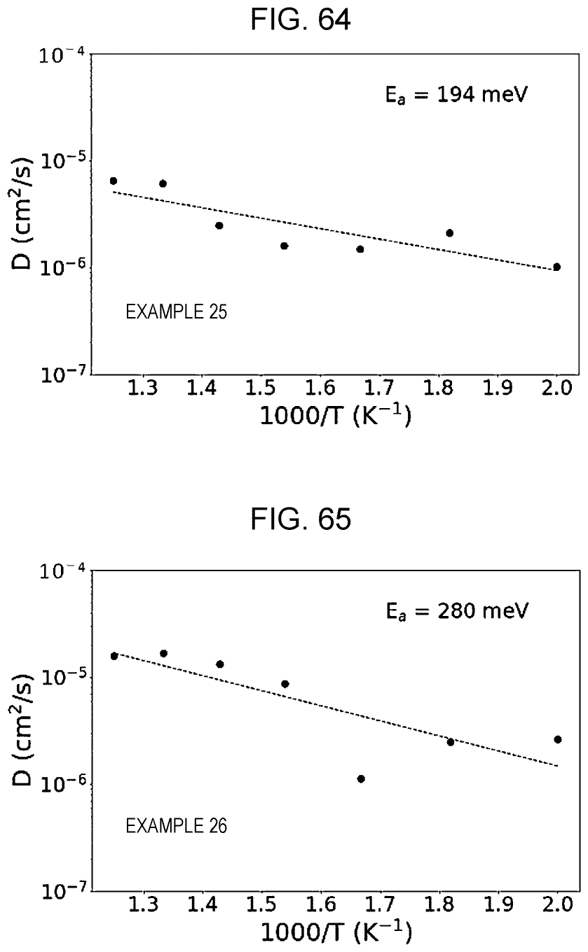

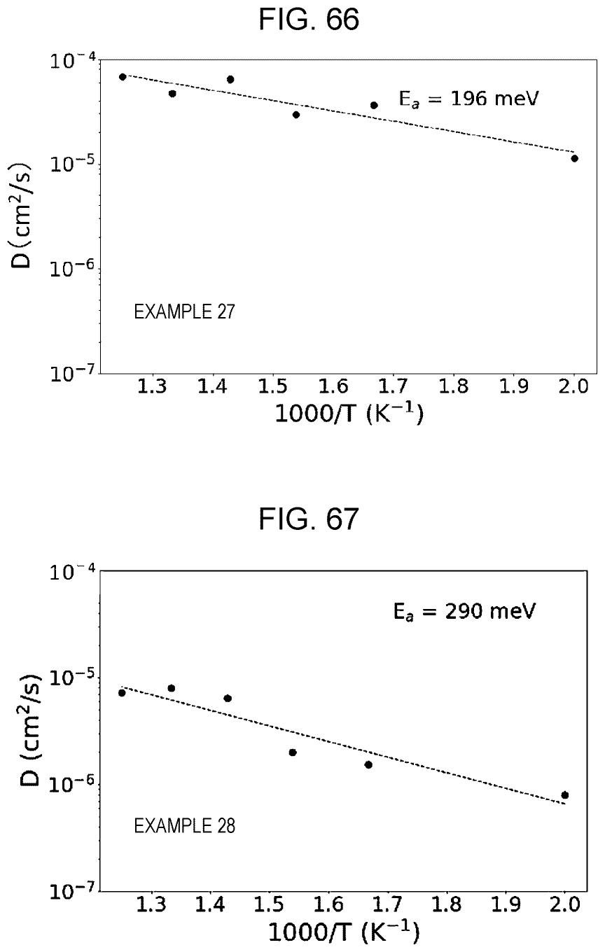

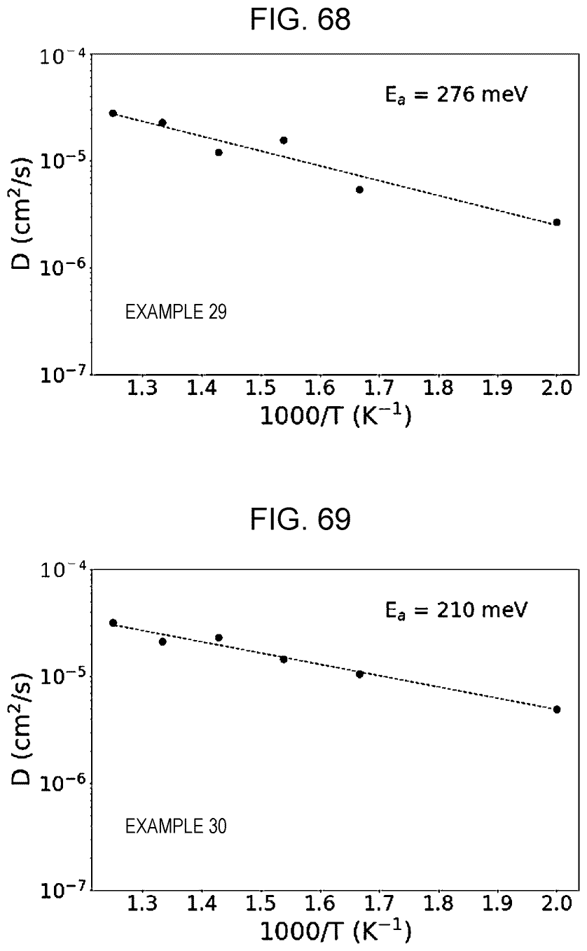

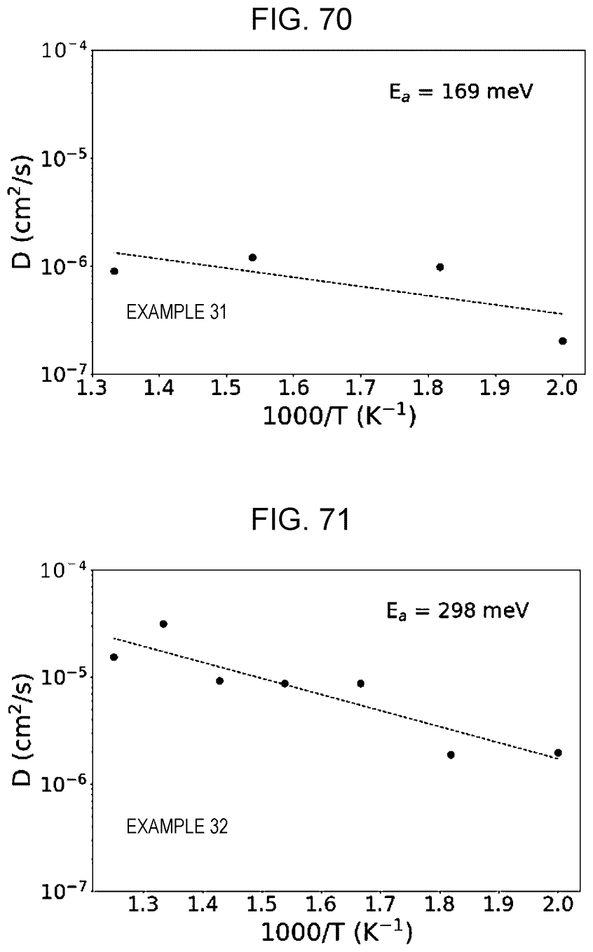

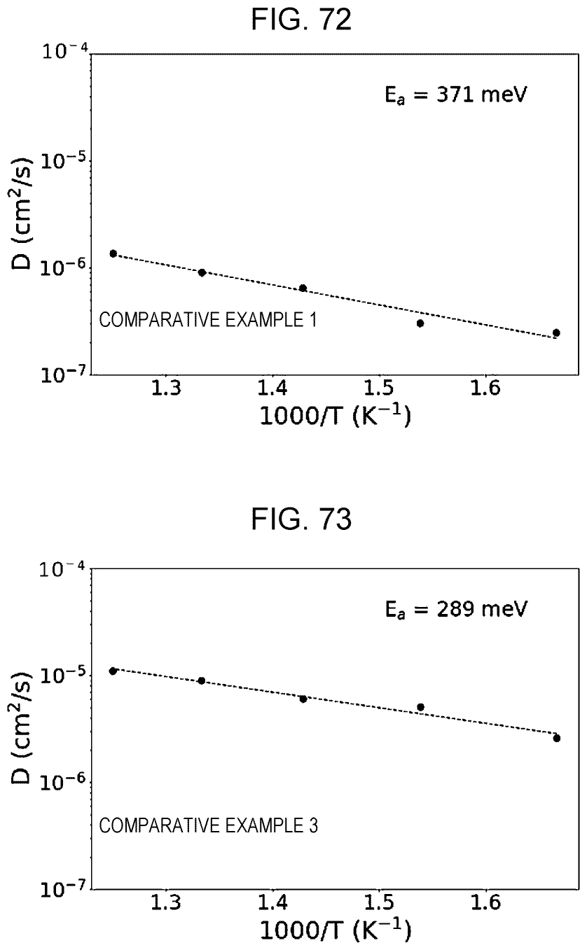

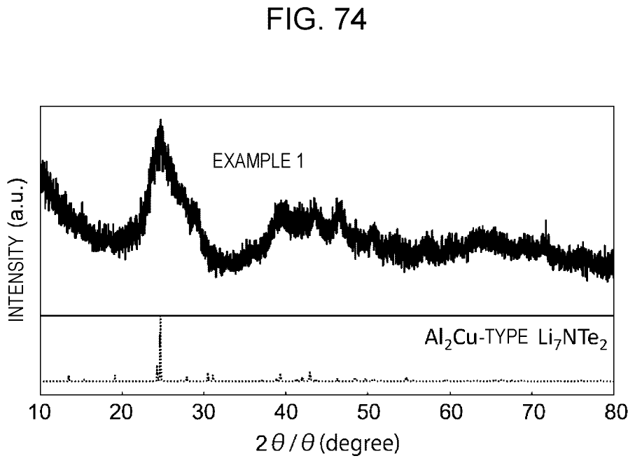

FIG. 30 is a view illustrating a crystal structure of the solid electrolyte material according to EXAMPLE 23 optimized by ab initio calculation.

FIG. 3I is a view illustrating a crystal structure of the solid electrolyte material according to EXAMPLE 24 optimized by ab initio calculation.

FIG. 32 is a view illustrating a crystal structure of the solid electrolyte material according to EXAMPLE 25 optimized by ab initio calculation.

FIG. 33 is a view illustrating a crystal structure of the solid electrolyte material according to EXAMPLE 26 optimized by ab initio calculation.

FIG. 52 is a graph illustrating the temperature dependence of the Li ion diffusion coefficient of the solid electrolyte material according to EXAMPLE 13 calculated by ab initio molecular dynamics calculation.

FIG. 53 is a graph illustrating the temperature dependence of the Li ion diffusion coefficient of the solid electrolyte material according to EXAMPLE 14 calculated by ab initio molecular dynamics calculation.

FIG. 54 is a graph illustrating the temperature dependence of the Li ion diffusion coefficient of the solid electrolyte material according to EXAMPLE 15 calculated by ab initio molecular dynamics calculation.

FIG. 55 is a graph illustrating the temperature dependence of the Li ion diffusion coefficient of the solid electrolyte material according to EXAMPLE 16 calculated by ab initio molecular dynamics calculation.

FIG. 56 is a graph illustrating the temperature dependence of the Li ion diffusion coefficient of the solid electrolyte material according to EXAMPLE 17 calculated by ab initio molecular dynamics calculation.

FIG. 57 is a graph illustrating the temperature dependence of the Li ion diffusion coefficient of the solid electrolyte material according to EXAMPLE 18 calculated by ab initio molecular dynamics calculation.

FIG. 58 is a graph illustrating the temperature dependence of the Li ion diffusion coefficient of the solid electrolyte material according to EXAMPLE 19 calculated by ab initio molecular dynamics calculation.

FIG. 59 is a graph illustrating the temperature dependence of the Li ion diffusion coefficient of the solid electrolyte material according to EXAMPLE 20 calculated by ab initio molecular dynamics calculation.

FIG. 60 is a graph illustrating the temperature dependence of the Li ion diffusion coefficient of the solid electrolyte material according to EXAMPLE 21 calculated by ab initio molecular dynamics calculation.

FIG. 61 is a graph illustrating the temperature dependence of the Li ion diffusion coefficient of the solid electrolyte material according to EXAMPLE 22 calculated by ab initio molecular dynamics calculation.

FIG. 62 is a graph illustrating the temperature dependence of the Li ion diffusion coefficient of the solid electrolyte material according to EXAMPLE 23 calculated by ab initio molecular dynamics calculation.

FIG. 63 is a graph illustrating the temperature dependence of the Li ion diffusion coefficient of the solid electrolyte material according to EXAMPLE 24 calculated by ab initio molecular dynamics calculation.

FIG. 64 is a graph illustrating the temperature dependence of the Li ion diffusion coefficient of the solid electrolyte material according to EXAMPLE 25 calculated by ab initio molecular dynamics calculation.

FIG. 65 is a graph illustrating the temperature dependence of the Li ion diffusion coefficient of the solid electrolyte material according to EXAMPLE 26 calculated by ab initio molecular dynamics calculation.

### Examples 27 to 30

Solid electrolyte materials according to EXAMPLES 27 to 30 are Li₇TeBr₅, Li₁₆IN₅, Li₁₆P₅I, and Li₁₆As₅I each having a CaCu₅-type tetrahedral composite structure.

FIG. 34 is a view illustrating a crystal structure of the solid electrolyte material according to EXAMPLE 27 optimized by ab initio calculation.

FIG. 35 is a view illustrating a crystal structure of the solid electrolyte material according to EXAMPLE 28 optimized by ab initio calculation.

FIG. 36 is a view illustrating a crystal structure of the solid electrolyte material according to EXAMPLE 29 optimized by ab initio calculation.

FIG. 37 is a view illustrating a crystal structure of the solid electrolyte material according to EXAMPLE 30 optimized by ab initio calculation.

FIG. 66 is a graph illustrating the temperature dependence of the Li ion diffusion coefficient of the solid electrolyte material according to EXAMPLE 27 calculated by ab initio molecular dynamics calculation.

FIG. 67 is a graph illustrating the temperature dependence of the Li ion diffusion coefficient of the solid electrolyte material according to EXAMPLE 28 calculated by ab initio molecular dynamics calculation.

FIG. 68 is a graph illustrating the temperature dependence of the Li ion diffusion coefficient of the solid electrolyte material according to EXAMPLE 29 calculated by ab initio molecular dynamics calculation.

FIG. 69 is a graph illustrating the temperature dependence of the Li ion diffusion coefficient of the solid electrolyte material according to EXAMPLE 30 calculated by ab initio molecular dynamics calculation.

### Examples 31 and 32

Solid electrolyte materials according to EXAMPLES 31 and 32 are Li₃CaSN and Li₃CaSbTe each having an FeB-type tetrahedral composite structure.

FIG. 38 is a view illustrating a crystal structure of the solid electrolyte material according to EXAMPLE 31 optimized by ab initio calculation.

FIG. 39 is a view illustrating a crystal structure of the solid electrolyte material according to EXAMPLE 32 optimized by ab initio calculation.

FIG. 70 is a graph illustrating the temperature dependence of the Li ion diffusion coefficient of the solid electrolyte material according to EXAMPLE 31 calculated by ab initio molecular dynamics calculation.

FIG. 71 is a graph illustrating the temperature dependence of the Li ion diffusion coefficient of the solid electrolyte material according to EXAMPLE 32 calculated by ab initio molecular dynamics calculation.

### Comparative Examples 1 to 4

### Preparation of Solid Electrolyte Materials

In COMPARATIVE EXAMPLE 1, Li₃N and Li₂Te were provided as ingredient powders so that the molar ratio Li₃N:Li₂Te would be 2:1.

In COMPARATIVE EXAMPLE 2, Li₃N and Li₂Te were provided as ingredient powders so that the molar ratio Li₃N:Li₂Te would be 1.75:1.25.

In COMPARATIVE EXAMPLE 4, Li₂Te was provided as an ingredient powder.

Solid electrolyte materials according to COMPARATIVE EXAMPLES 1, 2, and 4 were obtained in the same manner as in EXAMPLE 1 except for the above differences.

FIG. 40 is a view illustrating a crystal structure of the solid electrolyte material according to COMPARATIVE EXAMPLE 1 optimized by ab initio calculation.

FIG. 41 is a view illustrating a crystal structure of the solid electrolyte material according to COMPARATIVE EXAMPLE 4 optimized by ab initio calculation.

### Evaluation of Ionic Conductivity

The ionic conductivity of the solid electrolyte materials according to COMPARATIVE EXAMPLES 1, 2, and 4 was measured in the same manner as in EXAMPLE 1. The measurement results are described in Table 2.

### Computational Evaluation of Synthesizability

In COMPARATIVE EXAMPLES 1, 3, and 4, the synthesizability was computationally evaluated in the same manner as in EXAMPLE 1.

In COMPARATIVE EXAMPLE 3, Li₇NTe₂ models having a MgCu₂-type tetrahedral composite structure were evaluated.

### Computational Evaluation of Ionic Conductivity

In COMPARATIVE EXAMPLES 1, 3, and 4, the ionic conductivity was computationally evaluated in the same manner as in EXAMPLE 1.

FIG. 72 is a graph illustrating the temperature dependence of the Li ion diffusion coefficient of the solid electrolyte material according to COMPARATIVE EXAMPLE 1 calculated by ab initio molecular dynamics calculation.

FIG. 73 is a graph illustrating the temperature dependence of the Li ion diffusion coefficient of the solid electrolyte material according to COMPARATIVE EXAMPLE 3 calculated by ab initio molecular dynamics calculation.

TABLE 2

| | | | Ionic | Ionic | |
|---|---|---|---|---|---|
| | | | conductivity | conductivity | Convex_hull |
| | | Framework | (experimental) | (calculated) | energy |
| | Composition | type | (S/cm) | (S/cm) | (eV/atom) |
| COMP. EX. 1 | Li₈N₂Te | MgCu₂ | 3.3 × 10⁻⁵ | 6.3 × 10⁻⁵ | 0.000 |
| COMP. EX. 2 | Li_{7.75}N_{1.75}Te_{1.25} | MgCu₂ | 4.0 × 10⁻⁵ | — | — |
| COMP. EX. 3 | Li₇NTe₂ | MgCu₂ | — | 1.87 × 10⁻³ | 0.150 |
| COMP. EX. 4 | Li₂Te | fcc | 4.0 × 10⁻⁷ | No conduction | 0.000 |
| EX. 1 | Li₇NTe₂ | Al₂Cu | 7.6 × 10⁻⁵ | 5.34 × 10⁻² | 0.006 |
| EX. 2 | Li₉NTe₃ | Al₂Cu | 2.0 × 10⁻⁴ | — | — |
| EX. 3 | Li₂₃N₃Te₇ | Al₂Cu | 1.5 × 10⁻⁴ | — | — |
| EX. 4 | Li₇NSe₂ | Al₂Cu | 2.2 × 10⁻⁴ | 5.0 × 10⁻³ | 0.024 |
| EX. 5 | Li₈Br₅N | Al₂Cu | — | 6.75 × 10⁻² | 0.039 |
| EX. 6 | Li₈I₅N | Al₂Cu | — | 1.78 × 10⁻¹ | 0.025 |
| EX. 7 | Li₃ZnS₂F | Al₂Cu | — | 4.06 × 10⁻² | 0.058 |
| EX. 8 | Li₃MgSe₂F | Al₂Cu | — | 2.91 × 10⁻² | 0.058 |
| EX. 9 | Li₁₅Te₆N | Zr₄Al₃ | — | 7.71 × 10⁻³ | 0.060 |
| EX. 10 | Li₆Pb₂Cl₄O₃ | Zr₄Al₃ | — | 3.58 × 10⁻² | 0.025 |
| EX. 11 | Li₄Al₂Se₃I₄ | Zr₄Al₃ | — | 7.04 × 10⁻³ | 0.086 |
| EX. 12 | Li₄In₂S₃I₄ | Zr₄Al₃ | — | 8.00 × 10⁻¹ | 0.087 |
| EX. 13 | Li₁₀BrN₃ | Be₃Nb | — | 7.65 × 10⁻² | 0.052 |
| EX. 14 | Li₁₀IN₃ | Be₃Nb | — | 1.20 × 10⁻² | 0.032 |
| EX. 15 | Li₁₁SeN₃ | Be₃Nb | — | 2.60 × 10⁻² | 0.049 |
| EX. 16 | Li₁₁TeN₃ | Be₃Nb | — | 8.80 × 10⁻² | 0.046 |
| EX. 17 | Li₂₉Zn₂(SeN₃)₃ | Be₃Nb | — | 6.62 × 10⁻² | 0.038 |
| EX. 18 | Li₂₉Zn₂(TeN₃)₃ | Be₃Nb | — | 2.22 × 10⁻² | 0.035 |
| EX. 19 | Li₂₉Mg₂(SeN₃)₃ | Be₃Nb | — | 2.94 × 10⁻² | 0.060 |
| EX. 20 | Li₂₉Mg₂(TeN₃)₃ | Be₃Nb | — | 1.37 × 10⁻² | 0.056 |
| EX. 21 | Li₂₅Si₂(TeP₃)₃ | Be₃Nb | — | 3.12 × 10⁻¹ | 0.038 |
| EX. 22 | Li₂₅Ge₂(SN₃)₃ | Be₃Nb | — | 2.01 × 10⁻² | 0.055 |
| EX. 23 | Li₂₅Sn₂(TeN₃)₃ | Be₃Nb | — | 9.00 × 10⁻³ | 0.015 |
| EX. 24 | Li₂₄Ga₂(IN₃)₃ | Be₃Nb | — | 7.44 × 10⁻² | 0.059 |
| EX. 25 | Li₂₄In₂(IN₃)₃ | Be₃Nb | — | 1.29 × 10⁻² | 0.047 |
| EX. 26 | Li₂₇Al₂(TeP₃)₃ | Be₃Nb | — | 4.36 × 10⁻³ | 0.055 |
| EX. 27 | Li₇TeBr₅ | CaCu₅ | — | 8.19 × 10⁻² | 0.065 |
| EX. 28 | Li₁₆IN₅ | CaCu₅ | — | 2.75 × 10⁻³ | 0.085 |
| EX. 29 | Li₁₆P₅I | CaCu₅ | — | 8.47 × 10⁻³ | 0.097 |
| EX. 30 | Li₁₆As₅I | CaCu₅ | — | 4.21 × 10⁻² | 0.100 |
| EX. 31 | Li₃CaSN | FeB | — | 5.73 × 10⁻³ | 0.084 |
| EX. 32 | Li₃CaSbTe | FeB | — | 2.25 × 10⁻³ | 0.077 |

### Discussion

As is clear from Table 2, the solid electrolyte materials experimentally synthesized in EXAMPLES 1 to 4 have a high ion conductivity of greater than or equal to 7×10⁻⁵ S/cm at around room temperature. Furthermore, the calculated values of the ionic conductivity of the solid electrolyte materials according to EXAMPLES 5 to 32 are greater than or equal to 2×10⁻³ S/cm, and the ion conductivity is expected to be higher than those in COMPARATIVE EXAMPLES. Thus, high ion conductivity is obtained by designing a solid electrolyte material to include as an ion-conducting species at least one element selected from the group consisting of alkali metal elements and alkaline earth metal elements and to include an anionic framework that has a tetrahedral composite structure including at least one type of a polyhedron with no dihedral planes.

As described in S. Wenhao, et al., “The thermodynamic scale of inorganic crystalline metastability.” Science advances 2.11 (2016): e1600225., a convex hull energy of less than or equal to 0.1 eV indicates that the synthesis is feasible. Thus, the solid electrolyte materials according to EXAMPLES 5 to 32 are synthesizable.

The batteries according to EXAMPLES 1 to 4 were charged and discharged at room temperature.

As described above, the solid electrolyte materials according to the present disclosure can attain enhanced ionic conductivity and are suitable for providing batteries that can be favorably charged and discharged.

For example, the solid electrolyte materials of the present disclosure are used in batteries (for example, all-solid-state lithium ion secondary batteries).

What is claimed is:

1. A solid electrolyte material comprising:
an ion-conducting species; and
an anionic framework, wherein
the ion-conducting species is at least one element selected from the group consisting of alkali metal elements and alkaline earth metal elements, and
the anionic framework has a tetrahedral composite structure with no dihedral planes.

2. The solid electrolyte material according to claim 1, wherein
the tetrahedral composite structure has a structure belonging to at least one point group selected from the group consisting of Iₕ, Oₕ, Tₕ, Cₛ, Cᵢ, C₁, S₂ₙ, Dₙₕ, Dₙ, Cₙₕ, Cₙᵥ, and Cₙ, and
the letter n indicates an integer.

3. The solid electrolyte material according to claim 2, wherein
the tetrahedral composite structure has a structure belonging to at least one point group selected from the group consisting of Tₕ, C₂ᵥ, D₂ₕ, D₃ₕ, and D₄.

4. The solid electrolyte material according to claim 1, wherein
the anionic framework has a Zr₄Al₃-type structure, an Al₂Cu-type structure, an AlB₂-type structure, a ThSi₂-type structure, a CrB-type structure, an FeB-type structure, a CaCu₅-type structure, a NbBe₃-type structure, a Ce₂Ni₇-type structure, or a Th₂Zn₇-type structure.

5. The solid electrolyte material according to claim 1, wherein
the ion-conducting species comprises lithium.

6. The solid electrolyte material according to claim 5, wherein
the anionic framework has a Zr₄Al₃-type structure.

7. The solid electrolyte material according to claim 6, wherein
the solid electrolyte material is represented by compositional formula (1) or (2) below:
Li_{3x+4z}X₃Z₄ (1)
Li_{6x+z}X₆Z (2)
wherein
X and Z are anions,
X and Z are each independently at least one element selected from the group consisting of Group 14 elements, Group 15 elements, Group 16 elements, and Group 17 elements,
the letter x denotes the absolute value of the valence of X, and
the letter z denotes the absolute value of the valence of Z.

8. The solid electrolyte material according to claim 6, wherein
the solid electrolyte material is represented by compositional formula (3), (4), (5), or (6) below:
Li_{3x+4z-a}AX₃Z₄ (3)
Li_{3x+4z-2a}A₂X₃Z₄ (4)
Li_{6x+z-a}AX₆Z (5)
Li_{6x+z-2a}A₂X₆Z (6)
wherein
A is a cation,
X and Z are anions,
X and Z are each independently at least one element selected from the group consisting of Group 14 elements, Group 15 elements, Group 16 elements, and Group 17 elements,
A is at least one selected from the group consisting of alkali metal elements except Li, alkaline earth metal elements, transition metal elements, Group 13 elements, Group 14 elements, Group 15 elements, and Group 16 elements,
the letter x denotes the absolute value of the valence of X,
the letter z denotes the absolute value of the valence of Z, and
the letter a denotes the absolute value of the valence of A.

9. The solid electrolyte material according to claim 5, wherein
the anionic framework has an Al₂Cu-type structure.

10. The solid electrolyte material according to claim 9, wherein
the solid electrolyte material is represented by compositional formula (7) below:
Li_{2x+z}X₂Z (7)
wherein
X and Z are anions,
X and Z are each independently at least one element selected from the group consisting of Group 14 elements, Group 15 elements, Group 16 elements, and Group 17 elements,
the letter x denotes the absolute value of the valence of X, and
the letter z denotes the absolute value of the valence of Z.

11. The solid electrolyte material according to claim 9, wherein
the solid electrolyte material is represented by compositional formula (8) below:
Li_{3x+z}X₃Z (8)
wherein
X and Z are anions,
X and Z are each independently at least one element selected from the group consisting of Group 14 elements, Group 15 elements, Group 16 elements, and Group 17 elements,
the letter x denotes the absolute value of the valence of X, and
the letter z denotes the absolute value of the valence of Z.

12. The solid electrolyte material according to claim 9, wherein
the solid electrolyte material is represented by compositional formula (9) below:
Li_{7x+3z}X₇Z₃ (9)
wherein
X and Z are anions,
X and Z are each independently at least one element selected from the group consisting of Group 14 elements, Group 15 elements, Group 16 elements, and Group 17 elements,
the letter x denotes the absolute value of the valence of X, and
the letter z denotes the absolute value of the valence of Z.

13. The solid electrolyte material according to claim 9, wherein
the solid electrolyte material is represented by compositional formula (10) below:
Li_{5x+z}X₅Z (10)
wherein
X and Z are anions,
X and Z are each independently at least one element selected from the group consisting of Group 14 elements, Group 15 elements, Group 16 elements, and Group 17 elements,
the letter x denotes the absolute value of the valence of X, and
the letter z denotes the absolute value of the valence of Z.

14. The solid electrolyte material according to claim 9, wherein
the solid electrolyte material is represented by compositional formula (11) below:
Li_{2x+z-a}AX₂Z (11)
wherein
A is a cation,
X and Z are anions,
X and Z are each independently at least one element selected from the group consisting of Group 14 elements, Group 15 elements, Group 16 elements, and Group 17 elements,
A is at least one selected from the group consisting of alkali metal elements except Li, alkaline earth metal elements, transition metal elements, Group 13 elements, Group 14 elements, Group 15 elements, and Group 16 elements,
the letter x denotes the absolute value of the valence of X,
the letter z denotes the absolute value of the valence of Z, and
the letter a denotes the absolute value of the valence of A.

15. The solid electrolyte material according to claim 9, wherein
the solid electrolyte material is represented by compositional formula (12) below:
Li_{5x+z-a}AX₅Z (12)
wherein
A is a cation,
X and Z are anions,
X and Z are each independently at least one element selected from the group consisting of Group 14 elements, Group 15 elements, Group 16 elements, and Group 17 elements,
A is at least one selected from the group consisting of alkali metal elements except Li, alkaline earth metal elements, transition metal elements, Group 13 elements, Group 14 elements, Group 15 elements, and Group 16 elements,
the letter x denotes the absolute value of the valence of X,
the letter z denotes the absolute value of the valence of Z, and
the letter a denotes the absolute value of the valence of A.

16. The solid electrolyte material according to claim 9, wherein
the solid electrolyte material is represented by compositional formula (13) below:
Li_{4x+2z-a}AX₄Z₂ (13)
wherein
A is a cation,
X and Z are anions,
X and Z are each independently at least one element selected from the group consisting of Group 14 elements, Group 15 elements, Group 16 elements, and Group 17 elements,
A is at least one selected from the group consisting of alkali metal elements except Li, alkaline earth metal elements, transition metal elements, Group 13 elements, Group 14 elements, Group 15 elements, and Group 16 elements,
the letter x denotes the absolute value of the valence of X,
the letter z denotes the absolute value of the valence of Z, and
the letter a denotes the absolute value of the valence of A.

17. The solid electrolyte material according to claim 9, wherein
the solid electrolyte material is represented by compositional formula (14) below:
Li_{10x+2z-a}AX₁₀Z₂ (14)
wherein
A is a cation,
X and Z are anions,
X and Z are each independently at least one element selected from the group consisting of Group 14 elements, Group 15 elements, Group 16 elements, and Group 17 elements,
A is at least one selected from the group consisting of alkali metal elements except Li, alkaline earth metal elements, transition metal elements, Group 13 elements, Group 14 elements, Group 15 elements, and Group 16 elements,
the letter x denotes the absolute value of the valence of X,
the letter z denotes the absolute value of the valence of Z, and
the letter a denotes the absolute value of the valence of A.

18. The solid electrolyte material according to claim 9, wherein
the solid electrolyte material is represented by Li₇NTe₂, Li₉NTe₃, Li₂₃N₃Te₇, or Li₇NSe₂.

19. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the solid electrolyte material described in claim 1.
